(19) United States
(12) Patent Application Publication
(10) Pub. No.: US 2019/0219753 A1
(43) Pub. Date: Jul. 18, 2019

(54) LAMINATE AND WINDOW

(71) Applicant: FUJIFILM Corporation, Tokyo (JP)

(72) Inventors: Hideki KANEIWA, Minamiashigara-shi (JP); Yujiro YANAI, Minamiashigara-shi (JP); Akira YAMAMOTO, Minamiashigara-shi (JP)

(73) Assignee: FUJIFILM Corporation, Tokyo (JP)

(21) Appl. No.: 16/360,609

(22) Filed: Mar. 21, 2019

Related U.S. Application Data
(63) Continuation of application No. PCT/JP2017/034572, filed on Sep. 25, 2017.

(30) Foreign Application Priority Data
Sep. 29, 2016 (JP) 2016-192162
Sep. 21, 2017 (JP) 2017-180977

(51) Int. Cl. G02B 5/30; G02F 1/1335; C09K 19/04

(52) U.S. Cl. CPC G02B 5/3016; G02B 5/305; C09K 19/0403; G02B 5/3075; G02F 1/133536; G02B 5/3066

(57) ABSTRACT

A laminate has a first polarizer, a first patterned optical anisotropic layer, a second patterned optical anisotropic layer, and a second polarizer, in which an angle formed between transmission axes of the polarizers is 90°+5°; each of the patterned optical anisotropic layers has three or more phase difference regions, which have different slow axis directions and in which the slow axis directions continuously change, in a plane of each of the first patterned optical anisotropic layer and the second patterned optical anisotropic layer; a transmission display state and a light-blocking display state are switched with each other by changing an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer; a combination of the patterned optical anisotropic layers is a combination of a +A plate and −A plate; and at least one of the polarizers is a reflective-type polarizer.

### CROSS-REFERENCE TO RELATED APPLICATIONS

This application is a Continuation of PCT International Application No. PCT/JP2017/034572, filed on Sep. 25, 2017, which claims priority under 35 U.S.C. § 119(a) to Japanese Patent Application No. 2016-192162, filed on Sep. 29, 2016 and Japanese Patent Application No. 2017-180977, filed on Sep. 21, 2017. Each of the above application(s) is hereby expressly incorporated by reference, in its entirety, into the present application.

### BACKGROUND OF THE INVENTION

### 1. Field of the Invention

The present invention relates to a laminate and a window. More specifically, the present invention relates to a laminate, which can adjust transmittance between a transmission display state and a light-blocking display state, can display a reflection image in the light-blocking display state without displaying black, and causes less leakage of transmitted light in a case where the laminate is observed from the front and in an oblique direction in the light-blocking display state, and a window having the laminate.

### 2. Description of the Related Art

In recent years, as the protection of privacy has become more important and in order to save energy by allowing the external light to selectively come into buildings or vehicles, there has been a demand for light control devices (referred to as light control systems as well) such as windows having a shutter function by which windows, partitions of rooms, and the like are in a transmission display state (referred to as a white display state as well) and a light-blocking display state (referred to as black display state as well) switched with each other according to the time slot, the use, and the like.

JP2014-507676A describes a variable transmission device having a first patterned wavelength retarder, including a first uniform polarizer having a first polarization axis, a second uniform polarizer having a second polarization axis, and a plurality of first regions positioned between the first and second polarizers and constituted so as to change at least one of the light axis, the thickness, or the birefringence, and a second patterned wavelength retarder including a plurality of second regions positioned between the first and second polarizers and constituted so as to change at least one of the light axis, the thickness, or the birefringence, in which the first or second wavelength retarder is constituted so as to linearly move with respect to the other first or second wavelength retarder.

Furthermore, WO2015/033932A describes an optical filter capable of changing transmittance including a first polarizing plate, which has a first polarizer and a first patterned optical anisotropic layer, and a second polarizing plate, which has a second polarizer and a second patterned optical anisotropic layer, in which at least one of the first polarizer or the second polarizer is a reflective-type polarizer.

### SUMMARY OF THE INVENTION

In recent years, for examples, regarding the light control device described in JP2014-507676A, there has been news reporting that it is undesirable for the device to display black in a light-blocking state and it is preferable that the device displays a reflection image just like a mirror in the light-blocking state instead of displaying black by simply not transmitting light. Meanwhile, in WO2015/033932A, a reflective-type polarizer was used as a polarizer such that a reflection image can be displayed in the light-blocking state. However, as a result of examining the performance of the device described in WO2015/033932A, the inventors of the present invention found that in a case where the device was observed in an oblique direction in the light-blocking state, the transmitted light leaked, and accordingly, sometimes the other side was seen. In addition, in a case where an attempt was made to adjust the transmittance between the transmission display and the light-blocking display, a portion of a high transmittance and a portion of a low transmittance occurred in the form of stripes, and hence the device could not perform uniform display.

The present invention has been made under the circumstances described above, and an object thereof is to provide a laminate which can adjust transmittance between a transmission display state and a light-blocking display state, can display a reflection image in the light-blocking display state without displaying black, and causes less leakage of transmitted light in a case where the laminate is observed in an oblique direction.

In order to achieve the aforementioned object, the inventors of the present invention conducted an intensive examination. As a result, the inventors obtained knowledge that by using a laminate, which includes a first polarizer, a first patterned optical anisotropic layer, a second patterned optical anisotropic layer, and a second polarizer in this order and in which the first patterned optical anisotropic layer and the second patterned optical anisotropic layer have specific optical performance and at least one of the first polarizer or the second polarizer is a reflective-type polarizer, it is possible to provide a laminate which can adjust transmittance between a transmission display state and a light-blocking display state, can display a reflection image in the light-blocking display state without displaying black, and causes less leakage of transmitted light in a case where the laminate is observed from the front and in an oblique direction. Based on the knowledge, the present inventors have accomplished the present invention.

The present invention as means for achieving the object and preferable aspects of the present invention are as below.

[1] A laminate comprising a first polarizer, a first patterned optical anisotropic layer, a second patterned optical anisotropic layer, and a second polarizer in this order, in which an angle formed between a transmission axis of the first polarizer and a transmission axis of the second polarizer is 90°+5°; each of the first patterned optical anisotropic layer and the second patterned optical anisotropic layer has three or more phase difference regions, which have different slow axis directions and in which the slow axis directions continuously change, in a plane of each of the first patterned optical anisotropic layer and the second patterned optical anisotropic layer; a transmission display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 45°±5° and a transmittance obtained in a case where light incident on the first polarizer exits from the second polarizer is maximized, and a light-blocking display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 90°±5° and the transmittance obtained in a case where the light incident on the first polarizer exits from the second polarizer is minimized, are switched with each other; a combination of the first patterned optical anisotropic layer and the second patterned optical anisotropic layer is a combination of a +A plate and a −A plate; and at least one of the first polarizer or the second polarizer is a reflective-type polarizer.

[2] The laminate described in [1], in which one of the first polarizer and the second polarizer is a reflective-type polarizer and the other is an absorptive-type polarizer.

[3] The laminate described in [1] or [2], in which a retardation Re1(550) of the first patterned optical anisotropic layer at a wavelength of 550 nm in an in-plane direction of the first patterned optical anisotropic layer, a retardation Rth1(550) of the first patterned optical anisotropic layer at a wavelength of 550 nm in a film thickness direction of the first patterned optical anisotropic layer, a retardation Re2(550) of the second patterned optical anisotropic layer at a wavelength of 550 nm in an in-plane direction of the second patterned optical anisotropic layer, and a retardation Rth2(550) of the second patterned optical anisotropic layer at a wavelength of 550 nm in the in-plane direction of the second patterned optical anisotropic layer satisfy Formula (1) and Formula (2).

Re2(550)=Re1(550)±25 nm (1)

Rth2(550)=−Rth1(550)±25 nm (2)

[4] The laminate described in any one of [1] to [3], in which the retardation Re1(550) of the first patterned optical anisotropic layer at a wavelength of 550 nm in the in-plane direction of the first patterned optical anisotropic layer and the retardation Re2(550) of the second patterned optical anisotropic layer at a wavelength of 550 nm in the in-plane direction of the second patterned optical anisotropic layer are each independently 230 to 270 nm and satisfy Formula (1).

Re2(550)=Re1(550)±25 nm (1)

[5] The laminate described in any one of [1] to [4], in which both the first patterned optical anisotropic layer and the second patterned optical anisotropic layer have normal wavelength dispersion as wavelength dispersion of the retardation Re in the in-plane direction of the first patterned optical anisotropic layer and the second patterned optical anisotropic layer, and both the first patterned optical anisotropic layer and the second patterned optical anisotropic layer have normal wavelength dispersion as wavelength dispersion of the retardation Rth in the film thickness direction of the first patterned optical anisotropic layer and the second patterned optical anisotropic layer.

[6] The laminate described in any one of [1] to [5], in which the first patterned optical anisotropic layer and the second patterned optical anisotropic layer contain a liquid crystal compound.

[7] The laminate described in any one of [1] to [6], in which at one of the first patterned optical anisotropic layer or the second patterned optical anisotropic layer contains a disk-like liquid crystal compound.

[8] The laminate described in [7], in which one of the first patterned optical anisotropic layer and the second patterned optical anisotropic layer contains a disk-like liquid crystal compound and the other contains a rod-like liquid crystal compound.

[9] A window comprising the laminate described in any one of [1] to [8].

According to the present invention, it is possible to provide a laminate, which can adjust transmittance between a transmission display state and a light-blocking display state, can display a reflection image in the light-blocking display state without displaying black, and causes less leakage of transmitted light in a case where the laminate is observed from the front and in an oblique direction, and a window having the laminate.

### BRIEF DESCRIPTION OF THE DRAWINGS

FIG. 1 is a schematic view which relates to an example of an aspect of a laminate of according to an embodiment of the present invention and shows a transmission display state of the laminate.

FIG. 2 is a schematic view which relates to an example of an aspect of the laminate according to the embodiment of the present invention and shows a light-blocking display state of the laminate.

### DESCRIPTION OF THE PREFERRED EMBODIMENTS

Hereinafter, the present invention will be specifically described. The following constituents will be described based on typical embodiments of the present invention in some cases, but the present invention is not limited to the embodiments. In the present specification, a range of numerical values described using “to” means a range including the numerical values listed before and after “to” as a lower limit and an upper limit respectively.

In the present specification, Re(λ) represents an in-plane retardation at a wavelength λ, and Rth(λ) represents a retardation in a thickness direction at a wavelength λ. The unit of Re(λ) and Rth(λ) is nm. Re(λ) is measured by causing light having a wavelength of λ nm to be incident on a film in a normal direction of the film in KOBRA 21ADH or WR (manufactured by Oji Scientific Instruments). At the time of selecting the measurement wavelength λ nm, by manually replacing a wavelength selective filter or changing the measurement values by using a program or the like, the wavelength can be measured. In a case where the film to be measured is represented by a uniaxial or biaxial optical indicatrix, Rth(λ) is calculated by the method described below. This measurement method is also partially used for measuring an average tilt angle of disk-like liquid crystal molecules in an optically anisotropic layer, which will be described later, of an alignment layer side and measuring the average tilt angle of the opposite side.

For measuring Rth(λ), an in-plane slow axis (determined by KOBRA 21ADH or WR) is regarded as an axis of inclination (rotation axis) (in a case where no slow axis exists, any direction within the plane of a film is regarded as a rotation axis), and light having a wavelength of λ nm is caused to be incident on the film in a direction which inclines stepwise up to 500 to one side by 10° from the normal direction of the film. In this way, Re(λ) is measured at six spots in total, and KOBRA 21ADH or WR calculates Rth(λ) based on the measured retardation values, the assumptive value of an average refractive index, and the input value of film thickness. In the aforementioned method, in a case where a film is used in which a retardation value becomes zero along a certain direction at an angle of inclination about the in-plane slow axis as the rotation axis in the normal direction, the sign of the retardation value at an angle of inclination larger than the aforementioned angle of inclination is changed to a negative sign, and then KOBRA 21ADH or WR calculates Rth (λ). Herein, retardation values can be measured in any two inclined directions about the slow axis as the axis of inclination (rotation axis) (in a case where no slow axis exists, any direction within the plane of the film is used as a rotation axis), and based on the values, the assumptive value of an average refractive index, and the input value of film thickness, Rth can be calculated from Formula (A) and Formula (B).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Formula ( A )$$

Re(θ) represents a retardation value in a direction inclining at an angle of θ from the normal direction. In Formula (A), nx represents a refractive index in the slow axis direction within the plane, ny represents a refractive index in a direction orthogonal to nx within the plane, and nz represents a refractive index in a direction orthogonal to nx and ny. d represents a film thickness.

Rth=((nx+ny)/2−nz)×d Formula (B)

In a case where the film to be measured is a film which cannot be expressed as a uniaxial or biaxial optical indicatrix and does not have a so-called optic axis, Rth(λ) is calculated by the method described below. For obtaining Rth(λ), an in-plane slow axis (determined by KOBRA 21ADH or WR) is regarded as an axis of inclination (rotation axis), and light having a wavelength of λ nm is caused to be incident on a film in a direction inclining stepwise up to +50° from −50° by 10° with respect to the normal direction of the film. In this way, the aforementioned Re(λ) is measured at 11 spots in total, and based on the measured retardation values, the assumptive value of an average refractive index, and the input value of film thickness, KOBRA 21ADH or WR calculates Rth (λ). In the measurement described above, as the assumptive value of an average refractive index, it is possible to use values listed in Polymer Handbook (JOHN WILEY & SONS, INC) and in catalogs of various optical films. For the film whose average refractive index is not known, the average refractive index can be measured using an Abbe refractometer. For example, the values of the average refractive indices of main optical films are as below: cellulose acylate film (1.48), cycloolefin polymer (1.52), polycarbonate (1.59), polymethyl methacrylate (1.49), polystyrene (1.59). In a case where these assumptive values of average refractive index and the film thickness are input into KOBRA 21ADH or WR, the device calculates nx, ny, and nz. From the calculated nx, ny, and nz, Nz=(nx −nz)/(nx −ny) is additionally calculated.

In the present specification, “slow axis” of a phase difference film or the like means a direction along which a refractive index is maximized.

In the present specification, the numerical values, the range of numerical values, and the qualitative expressions (for example, expressions such as “equivalent” and “same”) showing the optical characteristics of various members such as a phase difference region, a phase difference film, and a liquid crystal layer are interpreted as showing the numerical values including generally accepted errors, the range of numerical values, and the properties of liquid crystal display devices and members used in the devices.

In the present specification, “front” means a normal direction with respect to a display surface.

In the present specification, unless otherwise specified, a measurement wavelength is 550 nm.

In the present specification, an angle (for example, an angle of “90°” or the like) and an angular relationship (for example, “orthogonal”, “parallel”, “intersecting at 450”, or the like) includes a margin of error acceptable in the technical field to which the present invention belongs. For example, the aforementioned angle means an angle which is within a range less than an accurate angle ±10°. The difference between the angle and an accurate angle is preferably equal to or smaller than ±5°, and more preferably equal to or smaller than ±3°.

The vertical alignment of a disk-like liquid crystal compound means that the disk-like liquid crystal compound is aligned such that the plane of the compound forms a polar angle of 0° with respect to a base material. The direction of a director of the vertically aligned disk-like liquid crystal compound is parallel to the base material.

The horizontal alignment of a disk-like liquid crystal compound means that the disk-like liquid crystal compound is aligned in a state where the plane of the disk-like liquid crystal compound is parallel to the support. The direction of a director of the horizontally aligned disk-like liquid crystal compound is a vertical direction

In a case where at least two sheets of patterned optical anisotropic layers are formed by the vertical alignment of a disk-like liquid crystal compound, the angle thereof may vary within a range of ±5°. In the present invention, the alignment state can be checked using Axo Scan (OPMF-1, manufactured by Axometrics, Inc).

[Laminate]

The laminate according to an embodiment of the present invention is a laminate including a first polarizer, a first patterned optical anisotropic layer, a second patterned optical anisotropic layer, and a second polarizer in this order, in which an angle formed between a transmission axis of the first polarizer and a transmission axis of the second polarizer is 90°±5°; each of the first patterned optical anisotropic layer and the second patterned optical anisotropic layer has three or more phase difference regions, which have different slow axis directions and in which the slow axis directions continuously change, in a plane each of the first patterned optical anisotropic layer and the second patterned optical anisotropic layer; a transmission display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 45°±5° and a transmittance obtained in a case where light incident on the first polarizer exits from the second polarizer is maximized, and a light-blocking display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 90°±5° and the transmittance obtained in a case where the light incident on the first polarizer exits from the second polarizer is minimized, are switched with each other; a combination of the first patterned optical anisotropic layer and the second patterned optical anisotropic layer is a combination of a +A plate and −A plate; and at least one of the first polarizer or the second polarizer is a reflective-type polarizer.

Due to the constitution described above, the laminate according to the embodiment of the present invention can adjust transmittance between a transmission display state and a light-blocking display state, can display a reflection image in the light-blocking display state without displaying black, and causes less leakage of transmitted light in a case where the laminate is observed from the front and in an oblique direction (a vertical direction and a horizontal direction) in the light-blocking display state. In the laminate according to the embodiment of the present invention, by moving each of the patterned optical anisotropic layers, the combination of the laminated phase difference regions of the patterned optical anisotropic layers can be changed. Accordingly, the sum of phase differences (rotatory polarization) of at least two sheets of patterned optical anisotropic layers changes, and as a result, it is possible to control the transmittance of light that is incident on one polarizer of the laminate and exits the other polarizer of the laminate.

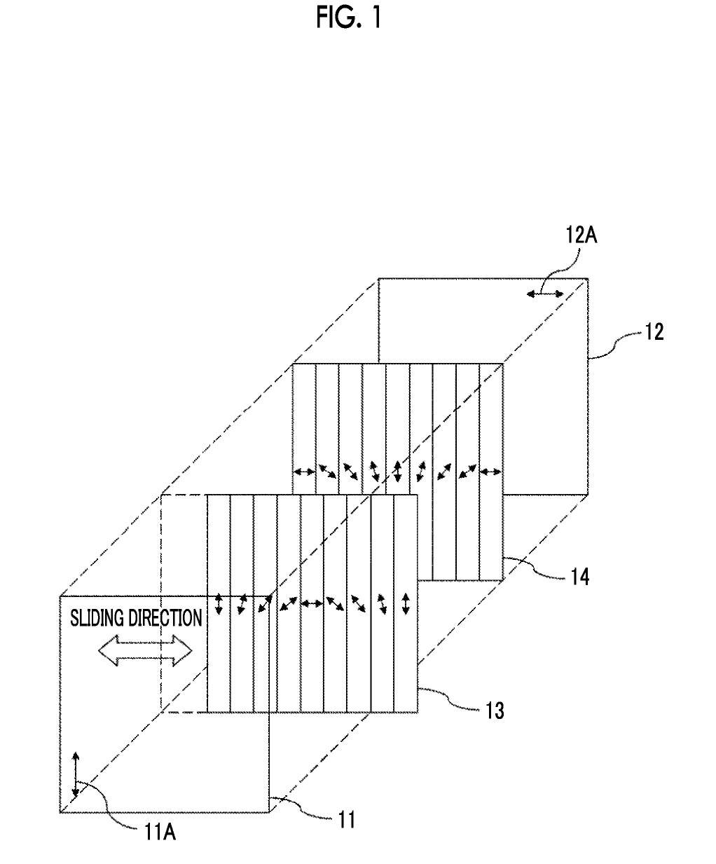

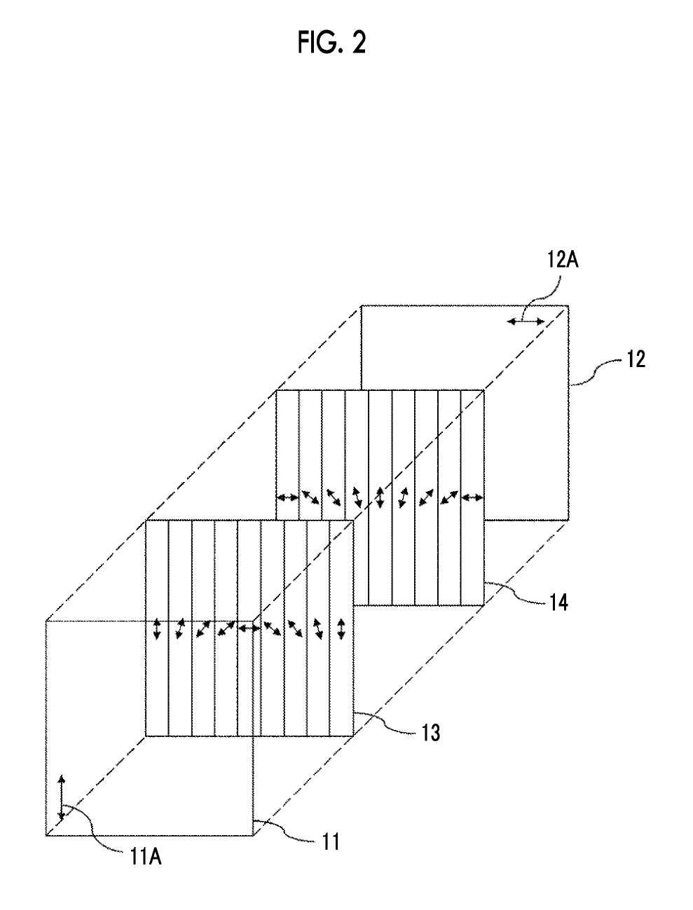

FIG. 1 and FIG. 2 are schematic cross-sectional views showing an example of the laminate according to the embodiment of the present invention. FIG. 1 and FIG. 2 are views showing different states of the same laminate. FIG. 1 shows a transmission display state, and FIG. 2 shows a reflection display state. The laminate according to the embodiment of the present invention shown in FIG. 1 and FIG. 2 has, for example, a first polarizer 11, a first patterned optical anisotropic layer 13, a second patterned optical anisotropic layer 14, and a second polarizer 12 in this order.

In the laminate according to the embodiment of the present invention shown in FIG. 1 and FIG. 2, for example, an angle formed between a transmission axis 11A of the first polarizer 11 and a transmission axis 12A of the second polarizer 12 is 90°±5°.

In an aspect of the laminate according to the embodiment of the present invention shown in FIG. 1 and FIG. 2, for example, each of the first patterned optical anisotropic layer 13 and the second patterned optical anisotropic layer 14 has three or more phase difference regions, which have different slow axis directions and in which the slow axis directions continuously change, in the plane thereof.

In the examples illustrated in the drawings, each of the first patterned optical anisotropic layer 13 and the second patterned optical anisotropic layer 14 is constituted with a plurality of long rectangular phase difference regions which have the same slow axis direction within the plane and are arranged in a direction orthogonal to a longitudinal direction. That is, each of the first patterned optical anisotropic layer 13 and the second patterned optical anisotropic layer 14 has a constitution in which a plurality of long rectangular phase difference regions having the same slow axis direction within the plane are arranged in the form of stripes. In the example illustrated in the drawings, the longitudinal direction of the rectangular phase difference regions is substantially the same as the direction of the transmission axis 11A of the first polarizer 11 (the angle formed between the longitudinal direction and the transmission axis 11A is 0°±5°). However, the laminate according to the embodiment of the present invention is not particularly limited to this positional relationship.

Furthermore, as being schematically indicated by the arrows in the phase difference regions of each of the first patterned optical anisotropic layer 13 and the second patterned optical anisotropic layer 14, the slow axis direction within the plane of the phase difference regions continuously change from 0° to 180° at a uniform angular interval along the arrangement direction of the phase difference regions. That is, in each of the first patterned optical anisotropic layer 13 and the second patterned optical anisotropic layer 14, the slow axis direction within the plane of the phase difference regions sequentially changes such that the slow axis rotates in one direction at a uniform angular interval along the arrangement direction of the phase difference regions. In the examples illustrated in the drawings, patterns in which the slow axis direction changes to 180° from 0° are shown. However, the combination of the slow axis directions of the patterned optical anisotropic layer of the present invention is not particularly limited to this example. For instance, patterns in which the slow axis direction changes to 90° from 0° may also be adopted. Alternatively, a plurality of patterns in which the slow axis direction changes to 180° from 0° and a plurality of patterns in which the slow axis direction changes to 90° from 0° may be repeated.

In addition, at least one of the first patterned optical anisotropic layer 13 or the second patterned optical anisotropic layer 14 is constituted such that one of them can move in the arrangement direction of the long phase difference regions. In the example illustrated in FIG. 1, as being indicated by the white arrow (sliding direction) in the drawing, the first patterned optical anisotropic layer 13 is constituted such that it can move in the arrangement direction of the phase difference regions.

The relative relationship between the layers in terms of the thickness shown in drawings does not reflect an actual relative relationship. The same shall be applied to all the drawings. As long as the gist of the present invention is not impaired, the laminate according to the embodiment of the present invention may have a support not shown in the drawing, an alignment film not shown in the drawing, an adhesive layer or a pressure sensitive adhesive layer not shown in the drawing, and the like between each of the members. The pressure sensitive adhesive is not particularly limited, and an adhesive may be used. Examples of usable pressure sensitive adhesives include a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinyl pyrrolidone-based pressure sensitive adhesive, a polyacrylamide-based pressure sensitive adhesive, a cellulose-based pressure sensitive adhesive, and the like.

FIG. 1 is a schematic view which relates to an example of the laminate according to the embodiment of the present invention and shows a transmission display state of the laminate. In the aspect of the laminate according to the embodiment of the present invention shown in FIG. 1, the laminate is in a transmission display state in which an angle formed between the slow axis direction of each of the phase difference regions of the first patterned optical anisotropic layer 13 and the slow axis direction of each of the phase difference regions of the second patterned optical anisotropic layer 14 that is superposed on each of the phase difference regions of the first patterned optical anisotropic layer 13 is 45°±5°, and a transmittance obtained in a case where light incident on the first polarizer 11 exits from the second polarizer 12 is maximized.

FIG. 2 is a schematic view which relates to an example of the laminate according to the embodiment of the present invention and shows a light-blocking display state of the laminate.

In the aspect of the laminate according to the embodiment of the present invention shown in FIG. 2, the laminate is in a reflection display state in which an angle formed between the slow axis direction of each of the phase difference regions of the first patterned optical anisotropic layer 13 and the slow axis direction of each of the phase difference regions of the second patterned optical anisotropic layer 14 that is superposed on each of the phase difference regions of the first patterned optical anisotropic layer 13 is 90°±5°, and the transmittance obtained in a case where the light incident on the first polarizer 11 exits from the second polarizer 12 is minimized.

The transmission display state and the light-blocking display state can be switched with each other by performing an operation of sliding any one of the patterned optical anisotropic layers by a width at which the transmission display state and the reflection display state can be switched with each other.

In the present invention, each of the patterned optical anisotropic layers has three or more phase difference regions in which the slow axis direction continuously changes. Therefore, the first patterned optical anisotropic layer 13 and the second patterned optical anisotropic layer 14 can be superposed such that the angle formed between the slow axis direction of each of the phase difference regions of the first patterned optical anisotropic layer 13 and the slow axis direction of each of the phase difference regions of the second patterned optical anisotropic layer 14 that is superposed on each of the phase difference regions of the first patterned optical anisotropic layer 13 becomes a value between 45° and 90°. In this case, the transmittance becomes a value that is in between the transmission display state and the reflection display state. That is, in the laminate according to the embodiment of the present invention, by adjusting the position, in which the first patterned optical anisotropic layer 13 and the second patterned optical anisotropic layer 14 are superposed, by means of sliding operation so as to control the angle formed between the slow axis directions of the corresponding phase difference regions of two patterned optical anisotropic layers, the transmittance can be adjusted to an arbitrary value.

In a case where the laminate according to the embodiment of the present invention that is in the transmission display state is observed in the front direction, it is preferable that the absolute value of Re of the first patterned optical anisotropic layer 13 is approximately the same as the absolute value of Re of the second patterned optical anisotropic layer 14, and Re preferably enables the patterned optical anisotropic layers to function as a λ/2 plate (abbreviation for a ½ wavelength plate).

It is preferable Re is as described above because then in a case where the angle formed between the slow axis direction of each of the phase difference regions of the first patterned optical anisotropic layer 13 and the slow axis direction of each of the phase difference regions of the second patterned optical anisotropic layer 14 that is superposed on each of the phase difference regions of the first patterned optical anisotropic layer 13 is set to be 45°±5° such that the laminate is in a transmission display state, it is easy to increase the transmittance of light which is incident on the first polarizer 11 and then exits from the second polarizer 12.

Furthermore, in a case where the laminate according to the embodiment of the present invention that is in a light-blocking display state is observed in the front direction, it is preferable that the absolute value of Re of the first patterned optical anisotropic layer 13 is approximately the same as the absolute value of Re of the second patterned optical anisotropic layer 14. It is preferable that Re is as described above because then in a case where the angle formed between the slow axis direction of each of the phase difference regions of the first patterned optical anisotropic layer 13 and the slow axis direction of each of the phase difference regions of the second patterned optical anisotropic layer 14 that is superposed on each of the phase difference regions of the first patterned optical anisotropic layer 13 is set to be 90°±5° such that the laminate is in a light-blocking display state, it is easy to reduce the minimum value of the transmittance of light which is incident on the first polarizer and then exits from the second polarizer. The minimum value of the transmittance can be reduced because Re of the first patterned optical anisotropic layer 13 and Re of the second patterned optical anisotropic layer 14 cancel each other out (phase difference cancellation).

<First Polarizer and Second Polarizer>

The laminate according to the embodiment of the present invention has the first polarizer 11 and the second polarizer 12. The constitutions common to the first polarizer 11 and the second polarizer 12 will be collectively described as a polarizer. Sometimes a polarizer is called by other names (“polarizing film” or “polarizing plate”) depending on the form thereof and whether or not the polarizer has a protective film. In the present invention, these are also called polarizer.

In the present invention, a reflective-type polarizer is used as at least one of the polarizers. The reflective-type polarizer has a property of transmitting a polarization component of a first direction and reflecting a polarization component of a direction orthogonal to the first direction among incidence rays. In the present invention, it is preferable to use a reflective-type linear polarizer.

The wavelength range (hereinafter, referred to as “control wavelength range” as well) of the light transmitted through or reflected by the reflective-type polarizer is not particularly limited. The wavelength range may be in the wavelength range of infrared light, the wavelength range of visible light, or the wavelength range of ultraviolet (ultraviolet rays (UV)). Furthermore, the wavelength range may be the wavelength range of infrared light and visible light, the wavelength range of visible light and ultraviolet, or the wavelength range of infrared light, visible light, and ultraviolet. Particularly, in view of further improving the heat blocking properties and the durability of an optical filter, the control wavelength range is preferably in the wavelength range of visible light or near infrared light.

Infrared light (infrared rays) is an electromagnetic wave in a wavelength range that is longer than that of visible rays but shorter than that of radio waves. Generally, near infrared light is an electromagnetic wave in a wavelength range longer than 750 nm and equal to or shorter than 2,500 nm. Among electromagnetic waves, visible rays refer to light which has a wavelength visible to the human eye and is in a wavelength range of 380 to 750 nm. Ultraviolet is an electromagnetic wave in a wavelength range that is shorter than that of visible rays but longer than X-rays. Ultraviolet may be light in a wavelength range differentiated from visible rays and X-rays. For example, ultraviolet is light having a wavelength in a range equal to or longer than 10 nm and shorter than 380 nm.

As the reflective-type polarizer, known polarizers can be used. For example, it is possible to use (i) polarizer obtained by laminating thin films having different birefringences, (ii) wire-grid type polarizer, and the like.

As (i) polarizer obtained by laminating thin films having different birefringences, for example, the polarizers described in JP1997-506837A (JP-H09-506837A) and the like can be used.

Specifically, in a case where processing is carried out under the conditions selected for obtaining a predetermined relationship of refractive index, the polarizer can be formed using a wide variety of materials. Generally, one first material needs to have a refractive index different from a refractive index of a second material in a selected direction. The difference in the refractive index can be achieved by various methods including stretching, extrusion molding, and coating performed during the formation of a film or after the formation of a film. Furthermore, it is preferable that the materials have similar rheological characteristics (for example, melt viscosity) such that two materials can be simultaneously extruded.

As the polarizer obtained by laminating thin films having different birefringences, commercially available products can be used. Examples of the commercially available products include DBEF (trade name) manufactured by 3M and the like.

(ii) Wire-grid type polarizer is a polarizer which transmits a polarized light while reflecting the other polarized light according to the birefringences of metal thin wires.

The wire-grid type polarizer is obtained by periodically arranging metal wires and used as a polarizer mainly in a terahertz wavelength range. In order for the wire-grid to function as a polarizer, the interval between the wires needs to be sufficiently shorter than the wavelength of incoming electromagnetic waves.

In the wire-grid type polarizer, metal wires are arranged at an equal interval. A polarization component in a polarization direction parallel to the longitudinal direction of the metal wires is reflected by the wire-grid type polarizer, and a polarization component in a polarization direction perpendicular to the longitudinal direction of the metal wires is transmitted.

As the wire-grid type polarizer, commercially available products can be used. Examples of the commercially available products include a wire-grid polarizing filter 50×50, NT46-636 manufactured by Edmund Optics Inc., and the like.

The thickness of the wire-grid type polarizer is preferably 0.05 to 300 μm, more preferably 0.2 to 150 μm, and even more preferably 0.5 to 100 μm.

As the reflective-type polarizer, it is also possible to use a reflective-type circular polarizer, a laminate of a circular polarizer and ¼ wavelength plate, and the like. As the reflective-type circular polarizer, for example, aligned cholesteric liquid crystals or a cured substance thereof can be used. As the reflective-type circular polarizer using aligned cholesteric liquid crystals, for example, it is possible to use the reflective-type circular polarizer described in paragraph <0099> in WO2015/033932A, the circularly polarized light separating layer described in paragraph <0087> in JP2014-219551A, and the like.

In the laminate according to the embodiment of the present invention, a reflective-type polarizer is used as a polarizer. Therefore, the laminate can display a reflection image instead of displaying black in the light-blocking display state.

In the present invention, it has been revealed that in a case where an absorptive-type polarizer is used in addition to a reflective-type polarizer, further improved effects can be obtained. That is, in the laminate according to the embodiment of the present invention, it is more preferable that one of the polarizers is a reflective-type polarizer and the other is an absorptive-type polarizer.

According to the constitution in which both the polarizers in the laminate according to the embodiment of the present invention are reflective-type polarizers, in the light-blocking display state, a reflection image is displayed, and in the transmission display state, a reflection image is displayed by being superposed on a transmission image.

In contrast, in a case where the laminate having a constitution, in which one of the polarizers is a reflective-type polarizer and the other is an absorptive-type polarizer, is observed from the absorptive-type polarizer side, in the light-blocking display state, a reflection image is displayed as described above. However, in the transmission display state, only a transmission image is displayed. Therefore, the visibility of the transmission image in the transmission display state is further improved.

Furthermore, in a case where the laminate having a constitution, in which one of the polarizers is a reflective-type polarizer and the other is an absorptive-type polarizer, is observed from the absorptive-type polarizer side in the transmission display state, only a transmission image is displayed and easily seen. In contrast, in a case where the laminate is observed from the reflective-type polarizer side, a reflection image is displayed by being superposed on a transmission image (similarly to the case where both the polarizers are reflective-type polarizers), and it is slightly difficult to see the image. This asymmetry is useful particularly in a case where it is desired to assure the visibility of the outside seen from the inside of private homes through a window or the like while reducing the visibility of the inside of the private homes seen from the outside.

The absorptive-type polarizer which can be used in the present invention is not particularly limited, and a wide variety of polarizers used in the related art can be used. The polarizers include an iodine-based polarizer, a colorant-based polarizer in which a dichroic colorant is used, a polyene-based polarizer, a polarizer in which a material causing polarization by absorbing UV is used, and the like. In the present invention, any of these may be used. The iodine-based polarizer and the colorant-based polarizer are generally manufactured using a polyvinyl alcohol-based film. Regarding the method for manufacturing the polarizer, for example, the description in JP2011-128584A can be referred to. Alternatively, it is also possible to use a polarizer obtained by mixing a liquid crystal compound with a dichroic colorant and aligning the molecules. In addition, a polarizer obtained by aligning molecules of a dichroic colorant such that the colorant has the properties of a liquid crystal, a polarizer obtained by mixing a dichroic colorant having the properties of a liquid crystal with a dichroic colorant without the properties of a liquid crystal and aligning the molecules, a polarizer obtained by mixing another liquid crystal compound with the above two polarizers and aligning the molecules, and the like may also be used. These polarizers may be used after the aligned molecules are immobilized by heat or light. Furthermore, each of these polarizers may be a layer formed by coating.

As the polarizer in which a material causing polarization by UV absorption is used, a material may be used in which both the degree of polarization and the concentration are increased by UV absorption. In a case where the polarizer, in which a material causing polarization by UV absorption is used, is used, while the laminate is not being irradiated with UV, the laminate is in the transmission display state all the time because the polarizer does not exhibit a polarization ability. In contrast, in a case where the laminate according to the embodiment of the present invention is irradiated with UV and absorbs UV, the polarizer, in which a material causing polarization by UV absorption is used, exhibits a polarization ability, and accordingly, a laminate which can be switched to the light-blocking display state can be prepared. Examples of the polarizer, in which a material causing polarization by UV absorption is used, include polarizing lenses manufactured by Transitions Optical, Inc., and the like.

In the laminate according to the embodiment of the present invention, the polarizers are preferably uniformly formed within the plane. That is, it is preferable that the polarizers are not patterned. In the polarizers, all the transmission axes are preferably in the same direction within the plane.

<Polarizer-Protective Film>

The laminate of the present invention may have a polarizer-protective film for protecting the polarizer, on at least one surface of the polarizer. In the aspect in which the polarizer is a layer formed by coating, the polarizer-protective film may be used as a support of the polarizer. The polarizer-protective film may be used as a support for the patterned optical anisotropic layer.

The polarizer-protective film is not particularly limited, and polymer films containing various polymer materials (meaning both the polymers and resins) as main components can be used. It is preferable to use films containing, as a main component, a polymer, a resin, and the like excellent in light-transmitting properties, mechanical strength, heat stability, moisture barrier properties, isotropy, and the like. Examples thereof include a polycarbonate-based polymer, a polyester-based polymer such as polyethylene terephthalate or polyethylene naphthalate, an acrylic polymer such as polymethyl methacrylate, a styrene-based polymer such as polystyrene or an acrylonitrile.styrene copolymer (AS resin), and the like. For example, it is possible to use a polyolefin such as polyethylene and polypropylene, a polyolefin-based polymer such as an ethylene.propylene copolymer, a vinyl chloride-based polymer, an amide-based polymer such as nylon and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl alcohol-based polymer, a vinyl butyral-based polymer, an arylate-based polymer, a polyoxymethylene-based polymer, an epoxy-based polymer, and a polymer obtained by mixing these polymers together. Furthermore, the polymer film can be formed as a cured layer of ultraviolet curable type and thermosetting type resins based on acryl, urethane, acrylurethane, epoxy, silicone, or the like.

As the polarizer-protective film, it is preferable to use a film containing, as a main component, at least one kind of compound selected from cellulose acylate, a cyclic olefin, an acrylic resin, a polyethylene terephthalate resin, and a polycarbonate resin.

In addition, as the polarizer-protective film, commercially available products may be used. For example, Zeonex and Zeonor manufactured by ZEON CORPORATION, ARTON manufactured by JSR Corporation, and the like can be used. Furthermore, various commercially available cellulose acylate films can also be used.

As the polarizer-protective film, it is possible to use films formed by any of the methods including a solution film-forming method and a melt film-forming method. The thickness of the polarizer-protective film is preferably 10 to 1,000 μm, more preferably 40 to 500 μm, and particularly preferably 40 to 200 μm.

The optical characteristics of the polarizer-protective film are not particularly limited. From the viewpoint of reducing the light leakage occurring at the time of observing the display state in the oblique direction, the polarizer-protective film is preferably an optically isotropic film, but the polarizer-protective film is not limited to this aspect. Specifically, the polarizer-protective film is preferably a film having Re(550) of 0 to 10 nm and an absolute value of Rth of equal to or smaller than 20 nm.

Any of the layers included in the laminate according to the embodiment of the present invention may contain an ultraviolet absorber so as to prevent the deterioration resulting from the solar light. The ultraviolet absorber may be added to any of the layers. For example, in an aspect, the polarizing plate-protective film contains the ultraviolet absorber. As the ultraviolet absorber, it is preferable to use an ultraviolet absorber which has an excellent ability to absorb ultraviolet having a wavelength of equal to or shorter than 370 nm and absorbs the visible light having a wavelength of equal to or longer than 400 nm as little as possible in view of the light-transmitting properties. Particularly, the transmittance of the ultraviolet absorber at a wavelength of 370 nm is desirably equal to or lower than 20%, preferably equal to or lower than 10%, and more preferably equal to or lower than 5%. Examples of such an ultraviolet absorber include an oxybenzophenone-based compound, a benzotriazole-based compound, a salicylic acid ester-based compound, a benzophenone-based compound, a cyanoacrylate-based compound, a nickel complex salt-based compound, a polymer ultraviolet absorbing compound containing the aforementioned ultraviolet-absorbing group, and the like. However, the present invention is not limited thereto, and two or more kinds of ultraviolet absorbers may be used.

In a case where the film containing an ultraviolet absorber is manufactured by a solution film-forming method, the ultraviolet absorber is added to a dope which is a solution of a main component polymer. The ultraviolet absorber may be added to the dope by a method in which the ultraviolet absorber is added after being dissolved in an alcohol or an organic solvent such as methylene chloride or dioxolane. The ultraviolet absorber may be directly added to the dope composition. The ultraviolet absorber such as inorganic powder that does not dissolve in an organic solvent is added to the dope after being dispersed in an organic solvent and the main component polymer by using a dissolver or a sand mill. Regarding a cellulose acylate film, it is particularly preferable to improve the light fastness thereof by adding an ultraviolet absorber.

The amount of the ultraviolet absorber used with respect to 100 parts by mass of the main component of the polarizer-protective film is preferably 0.1 to 5.0 parts by mass, more preferably 0.5 to 2.0 parts by mass, and particularly preferably 0.8 to 2.0 parts by mass.

<Patterned Optical Anisotropic Layer>

The laminate according to the embodiment of the present invention has the first polarizer 11, the first patterned optical anisotropic layer 13, the second patterned optical anisotropic layer 14, and the second polarizer 12 in this order.

The matters common to the first patterned optical anisotropic layer 13 and the second patterned optical anisotropic layer 14 will be collectively described as a patterned optical anisotropic layer in some cases.

In a case where the laminate according to the embodiment of the present invention includes three or more sheets of patterned optical anisotropic layers, the light control mode can be changed stepwise. However, from the viewpoint of increasing the transmittance in the transmission display state, it is preferable that laminate according to the embodiment of the present invention includes two sheets of patterned optical anisotropic layers.

Each of the first patterned optical anisotropic layer 13 and the second patterned optical anisotropic layer 14 has three or more phase difference regions, which have different slow axis directions and in which the slow axis directions continuously change, in the plane thereof. The number of phase difference regions, which have different slow axis directions and in which the slow axis directions continuously change, is not particularly limited because the number varies with the way the phase difference regions are divided. However, the number of phase difference regions is preferably 3 to 1,000, more preferably 5 to 100, and particularly preferably 10 to 50. In a case where the number of phase difference regions is too small, the gradations of concentration in between the transmission state and the light-blocking state are reduced, and hence the change of the transmittance becomes unnatural. In a case where the number of phase difference regions is too large, although there is no problem with performance, it is difficult to prepare the patterned optical anisotropic layer. The shape of each of the phase difference regions is not particularly limited.

However, it is preferable that the phase difference regions have approximately the same shape because then the patterned optical anisotropic layer looks natural in a case where the layer is slid. Furthermore, in view of making it easy to stack the phase difference regions, it is preferable that each of the phase difference regions has the shape of a long rectangle (shape of a stripe). The length of the rectangle in a short direction (width of the stripe) is preferably 0.01 to 30 mm.

The difference in an angle between the directions of the slow axes in the phase difference regions adjacent to each other in the arrangement direction (angular interval between the rotation directions of the slow axes) is not particularly limited, but is preferably 0.01° to 30° and more preferably 0.1° to 22.5°. In addition, it is preferable that the difference in an angle between the directions of the slow axes in the phase difference regions adjacent to each other in the arrangement direction is uniform.

(Optical Characteristics)

In the laminate according to the embodiment of the present invention, as a combination of the first patterned optical anisotropic layer 13 and the second patterned optical anisotropic layer 14, a combination of a +A plate and a −A plate is adopted. In a case where this combination is adopted, it is easy to obtain the preferable optical characteristics described so far.

Specifically, in a case where the aforementioned combination is adopted as the combination of the first patterned optical anisotropic layer 13 and the second patterned optical anisotropic layer 14, it is easy to satisfy both of Formulae (1) and (2) which will be described later, and accordingly, the leakage of transmitted light (light leakage) in the light-blocking display state that occurs in a case where the laminate is observed from the front and in an oblique direction (the laminate is observed in a tilted state) is reduced. Observing the laminate in an oblique direction is, in other words, observing the laminate in a direction forming an angle with a line perpendicular to the surface of the laminate (normal line of the laminate).

Particularly, at the time of observing the laminate in an oblique direction, for example, provided that a line extending in one direction along the longitudinal direction of the phase difference regions of the first patterned optical anisotropic layer 13 has an azimuthal angle of 0°, the leakage of the transmitted light in the light-blocking display state is suitably reduced in a case where the laminate is observed in a direction of an azimuthal angle of 0° (around 0°), in a case where the laminate is observed in a direction of an azimuthal angle of 90° (around 90°), in a case where the laminate is observed in a direction of an azimuthal angle of 180° (around 180°), and in a case where the laminate is observed in a direction of an azimuthal angle of 270° (around 270°).

In the laminate according to the embodiment of the present invention, the retardation Re1(550) of the first patterned optical anisotropic layer 13 at a wavelength of 550 nm in the in-plane direction, the retardation Rth1(550) of the first patterned optical anisotropic layer 13 at a wavelength of 550 nm in the film thickness direction, the retardation Re2(550) of the second patterned optical anisotropic layer 14 at a wavelength of 550 nm in the in-plane direction, and the retardation Rth2(550) of the second patterned optical anisotropic layer 14 at a wavelength of 550 nm in the in-plane direction preferably satisfy Formula (1) and Formula (2). In a case where the formulae are satisfied, it is possible to further reduce the leakage of the transmitted light in the light-blocking display state. Specifically, in a case where Formula (1) is satisfied, the light leakage in the light-blocking display state that occurs in a case where the laminate is observed from the front is reduced. Furthermore, in a case where both of Formulae (1) and (2) are satisfied, the leakage of the transmitted light in the light-blocking display state that occurs in a case where the laminate is observed in an oblique direction (in addition to the front) is reduced.

Re2(550)=Re1(550)±25 nm (1)

Rth2(550)=−Rth1(550)±25 nm (2)

Furthermore, the laminate according to the embodiment of the present invention more preferably satisfies Formula (1A), and particularly preferably satisfies Formula (1B).

Re2(550)=Re1(550)±10 nm (1A)

Re2(550)=Re1(550)±3 nm (1B)

In addition, the laminate according to the embodiment of the present invention more preferably satisfies Formula (2A), and particularly preferably satisfies Formula (2B).

Rth2(550)=−Rth1(550)±10 nm (2A)

Rth2(550)=−Rth1(550)±3 nm (2B)

Furthermore, it is preferable that the retardation Re1(550) of the first patterned optical anisotropic layer 13 at a wavelength of 550 nm in the in-plane direction of the first patterned optical anisotropic layer 13 and the retardation Re2(550) of the second patterned optical anisotropic layer 14 at a wavelength of 550 nm in the in-plane direction of the second patterned optical anisotropic layer 14 are each independently 230 to 270 nm and satisfy Formula (1). In a case where the formula is satisfied, the transmittance in the transmission display state can be increased.

Re2(550)=Re1(550)+10 nm (1)

In the laminate according to the embodiment of the present invention, the retardation Re1(550) of the first patterned optical anisotropic layer 13 at a wavelength of 550 nm in the in-plane direction of the first patterned optical anisotropic layer 13 and the retardation Re2(550) of the second patterned optical anisotropic layer 14 at a wavelength of 550 nm in the in-plane direction of the second patterned optical anisotropic layer 14 are each independently more preferably 230 to 260 nm, particularly preferably 230 to 250 nm, and more particularly preferably 235 to 245 nm.

In the laminate according to the embodiment of the present invention, it is preferable that both the first patterned optical anisotropic layer 13 and the second patterned optical anisotropic layer 14 have any of normal wavelength dispersion, reciprocal wavelength dispersion, and flat dispersion as wavelength dispersion of the retardation Re in the in-plane direction. Furthermore, in the laminate according to the embodiment of the present invention, it is preferable that both the first patterned optical anisotropic layer 13 and the second patterned optical anisotropic layer 14 have any of normal wavelength dispersion, reciprocal wavelength dispersion, and flat dispersion as wavelength dispersion of the retardation Rth in the film thickness direction.

In the laminate according to the embodiment of the present invention, it is more preferable that both the first patterned optical anisotropic layer 13 and the second patterned optical anisotropic layer 14 have normal wavelength dispersion as wavelength dispersion of the retardation Re in the in-plane direction. Furthermore, it is more preferable that both the first patterned optical anisotropic layer 13 and the second patterned optical anisotropic layer 14 have normal wavelength dispersion as wavelength dispersion of the retardation Rth in the film thickness direction.

In the laminate according to the embodiment of the present invention, it is preferable that the first patterned optical anisotropic layer 13 and the second patterned optical anisotropic layer 14 contain a liquid crystal compound. The liquid crystal compound used in the first patterned optical anisotropic layer 13 and the second patterned optical anisotropic layer 14 will be described later. However, it is preferable that at least one of the first patterned optical anisotropic layer 13 or the second patterned optical anisotropic layer 14 uses a disk-like liquid crystal compound. It is more preferable that one of the first patterned optical anisotropic layer 13 and the second patterned optical anisotropic layer 14 uses a disk-like liquid crystal compound and the other uses a rod-like liquid crystal compound.

The patterned optical anisotropic layer may be formed on the surface of a support formed of a polymer film or the like and incorporated into a polarizer together with the support. This constitution is particularly preferable because the support of the patterned optical anisotropic layer can also be used as a polarizer-protective film. As the support, a light-transmitting polymer film is preferable. Examples of the polymer film which can be used as a support are the same as the examples of the polymer film which can be used as a polarizer-protective film.

(Material of Patterned Optical Anisotropic Layer)

As the material of the patterned optical anisotropic layer, a liquid crystal composition containing a liquid crystal compound is preferable. The liquid crystal composition is preferably a polymerizable liquid crystal composition containing a liquid crystal compound having a polymerizable group.

As one of the liquid crystal compositions used for forming the patterned optical anisotropic layer, a liquid crystal composition can be exemplified which contains at least one kind of liquid crystal compound having a polymerizable group and at least one kind of alignment control agent. The liquid crystal composition may also contain other components such as a polymerization initiator, a sensitizer, and an alignment aid.

Hereinafter, each of the materials will be specifically described.

—Liquid Crystal Compound—

The liquid crystal compound can be appropriately selected according to the values of Re and Rth of the patterned optical anisotropic layers and the design of the wavelength dispersion of Re and Rth of the patterned optical anisotropic layers.

In order to make the patterned optical anisotropic layers have normal wavelength dispersion as wavelength dispersion of Re, for example, it is preferable to use liquid crystal compounds described below.

Examples of the liquid crystal compounds include a rod-like liquid crystal compound and a disk-like liquid crystal compound.

——Rod-Like Liquid Crystal Compound——

Examples of the rod-like liquid crystal compound include a rod-like nematic liquid crystal compound. As the rod-like nematic liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolanes, and alkenylcyclohexyl benzonitriles are preferably used. Not only the aforementioned low-molecular weight liquid crystal molecules, but also polymer liquid crystal molecules can be used.

The polymerizable liquid crystal compound having a polymerizable group for which the alignment of the rod-like liquid crystal compound is more preferably immobilized by polymerization can be obtained by introducing a polymerizable group into a liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is particularly preferable. The polymerizable group can be introduced into the liquid crystal compound molecule by various methods. The number of polymerizable groups contained in the polymerizable liquid crystal compound is preferably 1 to 6, and more preferably 1 to 3. Examples of the polymerizable liquid crystal compound include the compounds described in Makromol. Chem., vol. 190, p. 2255 (1989); Advanced Materials, vol. 5, p. 107 (1993), U.S. Pat. Nos. 4,683,327B, 5,622,648B, 5,770,107B, WO95/22586A, WO95/24455A, WO97/00600A, WO98/23580A, WO98/052905A, JP1989-272551A (JP-H01-272551A), JP1994-16616A (JP-H06-16616A), JP1995-110469A (JP-H07-110469A), JP1999-80081A (JP-H11-80081A), JP2001-328973A, JP2014-198815A, JP2014-198814A, and the like. Furthermore, as the rod-like liquid crystal compound, for example, the compounds described in JP1999-513019A (JP-H11-513019A) and JP2007-279688A can also be preferably used.

Two or more kinds of polymerizable liquid crystal compounds may be used in combination. In a case where two or more kinds of polymerizable liquid crystal compounds are used in combination, the alignment temperature can be reduced.

Specific examples of the rod-like liquid crystal compound include compounds represented by Formulae (1) to (11).

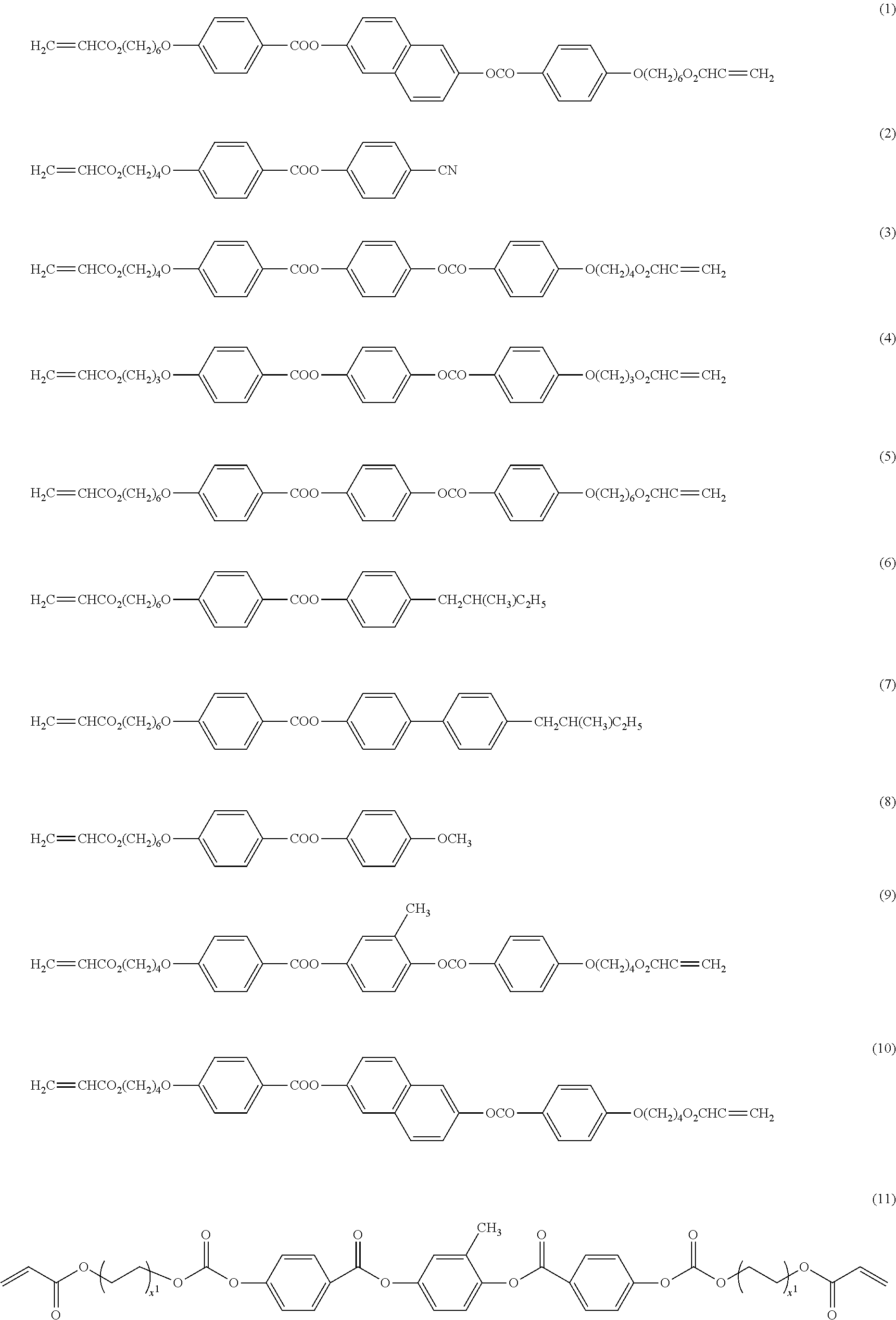

[In compound (11), X¹ is 2 to 5 (integer).]

Preferable examples of compounds used in a case where two or more rod-like liquid crystal compounds are used in combination will be shown below, but the present invention is not limited thereto.

Rod-Like Liquid Crystal Compounds

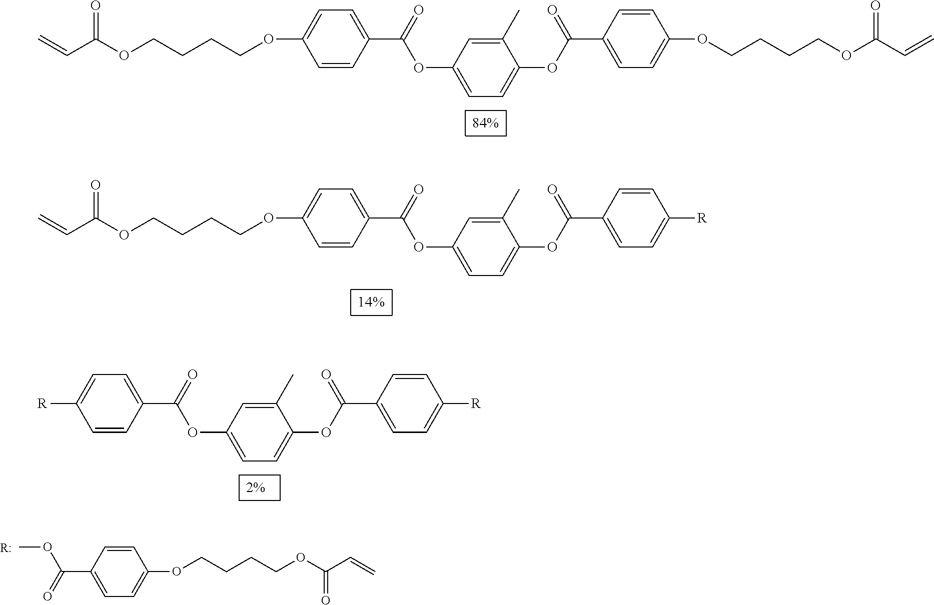

——Disk-Like Liquid Crystal Compound——

As the disk-like liquid crystal compound, for example, the compounds described in JP2007-108732A and JP2010-244038A can be preferably used, but the present invention is not limited thereto.

Preferable examples of the disk-like liquid crystal compound will be shown below, but the present invention is not limited thereto. The disk-like liquid crystal compound is also referred to as discotic liquid crystal compound which is another English term.

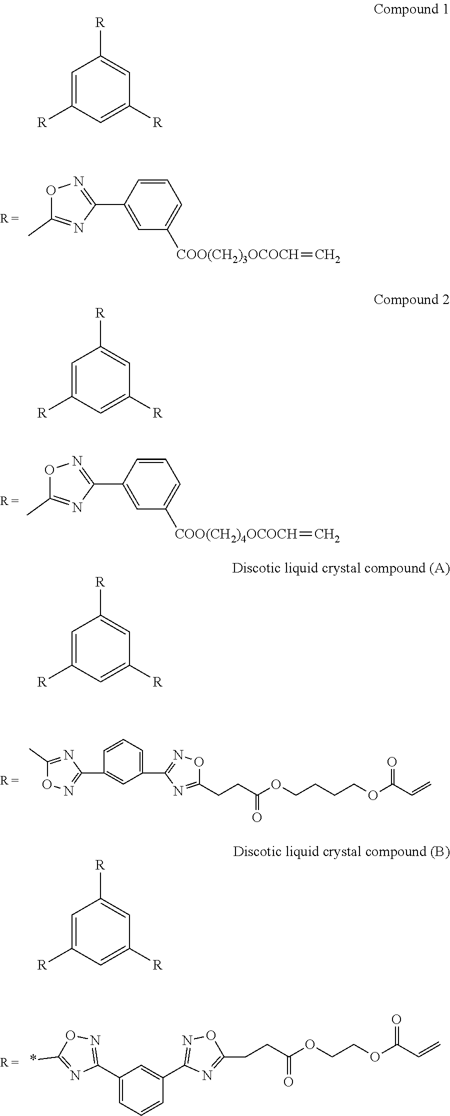

The amount of the liquid crystal compound added to the liquid crystal composition with respect to the mass of solid contents (mass excluding the solvent) of the liquid crystal composition is preferably 75% to 99.9% by mass, more preferably 80% to 99% by mass, and particularly preferably 85% to 90% by mass.

——Smectic Liquid Crystal Compound——

In order to make the patterned optical anisotropic layers have reciprocal wavelength dispersion as wavelength dispersion of Re, for example, it is preferable to use a smectic liquid crystal compound described below.

The smectic liquid crystal compound refers to a compound which enables the formed patterned optical anisotropic layer or optically anisotropic layer to exhibit the properties of a smectic liquid crystal.

The patterned optical anisotropic layer or the optically anisotropic layer exhibiting the properties of a smectic liquid crystal also includes a patterned optical anisotropic layer or an optically anisotropic layer that does not perfectly exhibit the properties of a smectic liquid crystal due to curing and the like. Therefore, the aforementioned patterned optical anisotropic layer or the optically anisotropic layer includes not only an optically anisotropic layer in which an alignment order parameter, which will be described later, is within a range of 0.8 to 1.0, but also, for example, an optically anisotropic layer which has one peak within a range of 2θ, which is an angle formed between an incident beam and a diffracted beam, of 1° to 3° determined by measuring a period in a direction parallel to the alignment direction of liquid crystals by using X-ray diffractometry.

Among these smectic liquid crystal compounds, a compound not containing a fluorine atom in the molecule is preferably used.

As the smectic liquid crystal compound, a compound having at least three ring structures selected from the group consisting of a benzene ring and a cyclohexane ring is preferable, because such a compound easily expresses smectic properties by the quasi-phase separation between a rigid mesogen and a flexible side chain and exhibits sufficient rigidity.

Furthermore, from the viewpoint of imparting moisture-heat resistance to the patterned optical anisotropic layer, a compound is preferable which has two or more polymerizable groups (for example, a (meth)acryloyl group, a vinyl group, a styryl group, an allyl group, and the like).

The description of “(meth)acryloyl group” represents an acryloyl group or a methacryloyl group.

Specific examples of the aforementioned smectic liquid crystal compound include compounds represented by Formulae L-1, L-3, and L-6, and the like.

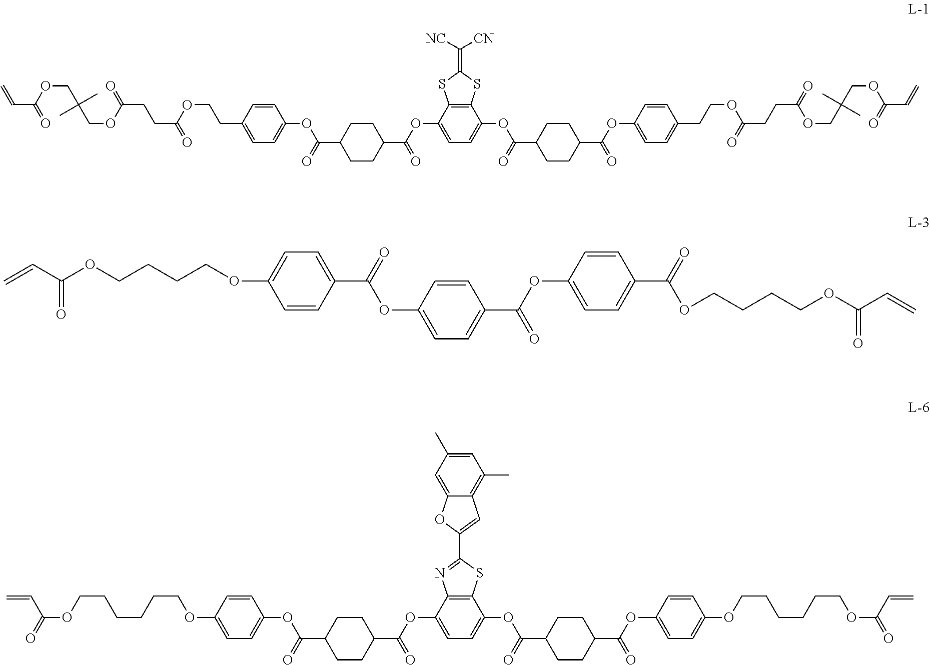

In addition, as the smectic liquid crystal compound, a compound having a structure represented by Formula (I) is preferable, because such a compound further improves the alignment properties of the patterned optical anisotropic layer by the electronic interaction between liquid crystal molecules.

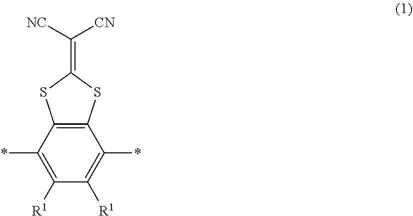

In Formula (I), * represents a binding position, and R¹ each independently represents a hydrogen atom or an alkyl group having 1 to 6 carbon atoms.

Examples of the compound having the structure represented by Formula (I) suitably include the compound represented by Formula L-1 in which all R¹'s in Formula (I) represent a hydrogen atom.

The patterned optical anisotropic layer used in a case where reciprocal wavelength dispersion is adopted as the wavelength dispersion of Re may contain other liquid crystal compounds in addition to the aforementioned smectic liquid crystal compound.

Examples of other liquid crystal compounds include a nematic liquid crystal compound and the like. Specific examples thereof include compounds represented by Formulae L-2 and L-4 that are used in examples which will be described later.

In a case where the patterned optical anisotropic layer contains the aforementioned smectic liquid crystal compound and other liquid crystal compounds, the content ratio of the smectic liquid crystal compound with respect to the total mass of the smectic liquid crystal compound and other liquid crystal compounds is preferably at least equal to or higher than 35% by mass.

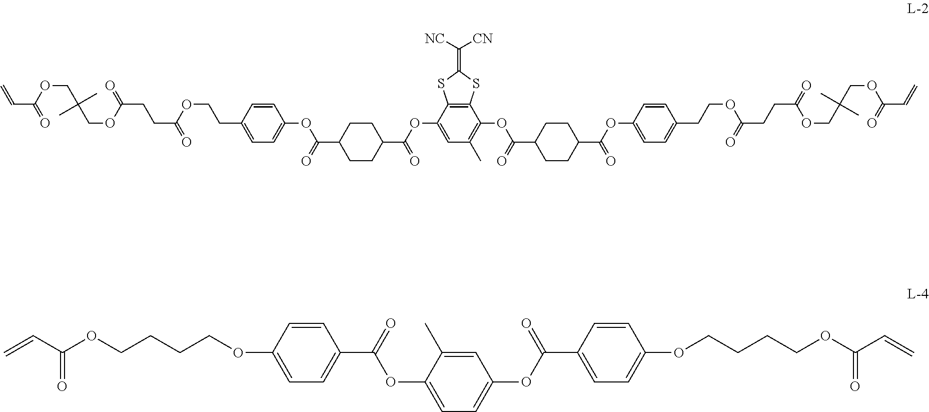

—Alkylcyclohexane Ring-Containing Compound—

The patterned optical anisotropic layer used in a case where reciprocal wavelength dispersion is adopted as the wavelength dispersion at Re preferably contains an alkylcyclohexane ring-containing compound. The alkylcyclohexane ring-containing compound is a compound having a cyclohexane ring, in which one hydrogen atom is substituted with a linear alkyl group, in a portion thereof.

Herein, for example, in a case where the compound has two cyclohexane rings as shown in Formula (2), “cyclohexane ring in which one hydrogen atom is substituted with a linear alkyl group” refers to a cyclohexane ring which is present on the molecular terminal side and in which one hydrogen atom is substituted with a linear alkyl group.

Examples of the alkylcyclohexane ring-containing compound include a compound having a structure represented by Formula (2). From the viewpoint of imparting moisture-heat resistance to the optically anisotropic layer, a compound represented by Formula (3) having a (meth)acryloyl group is preferable.

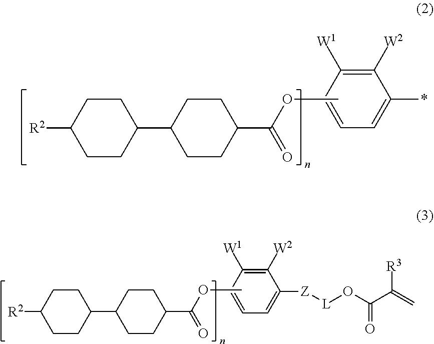

In Formula (2), * represents a binding position.

In Formulae (2) and (3), R² represents an alkyl group having 1 to 10 carbon atoms, n represents 1 or 2, W¹ and W² each represent an alkyl group, an alkoxy group, or a halogen atom. Furthermore, W¹ and W² may form a ring structure which may have a substituent by being bonded to each other.

In Formula (3), Z represents —COC— or —OCO—, L represents an alkylene group having 1 to 6 carbon atoms, and R³ represents a hydrogen atom or a methyl group.

Specific examples of the alkylcyclohexane ring-containing compound include compounds represented by Formulae A-1 to A-5. In Formula A-3, R⁴ represents an ethyl group or a butyl group.

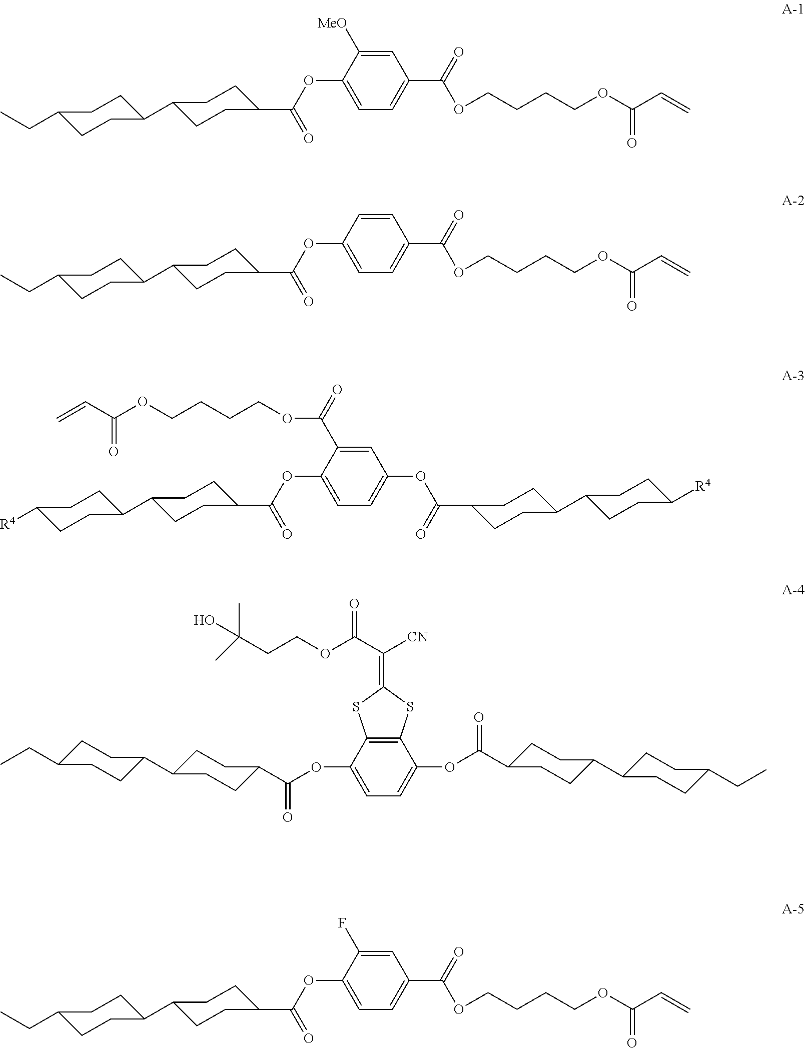

—Alignment Control Agent—

The liquid crystal composition may contain an alignment control agent. Examples of the alignment control agent include the compounds exemplified in paragraphs <0092> and <0093> in JP2005-99248A, the compounds exemplified in paragraphs <0076> to <0078> and <0082> to <0085> in JP2002-129162A, the compounds exemplified in paragraphs <0094> and <0095> in JP2005-99248A, and the compounds exemplified in paragraph <0096> in JP2005-99248A.

As a fluorine-based alignment control agent, the compounds described in paragraphs <0082> to <0090> in JP2014-119605A and the fluorine (meth)acrylate-based polymers described in paragraphs <0018> to <0043> and the like in JP2007-272185A are preferable.

As the alignment control agent, the fluorine (meth)acrylate-based polymers described in paragraphs <0018> to <0043> in JP2007-272185A can be preferably used, and the description of the specification is incorporated into the present invention.

One kind of alignment control agent may be used singly, or two or more kinds thereof may be used in combination.

In a case where a patterned optical anisotropic layer which is a −A plate is formed, it is preferable to form a patterned optical anisotropic layer in which the disk-like liquid crystal compound having a polymerizable group is vertically aligned. In this case, as the alignment control agent in the liquid crystal composition, it is preferable to use an onium salt compound (alignment control agent for the alignment film side) and/or a fluoroaliphatic group-containing copolymer.

——Onium Salt Compound (Alignment Control Agent for Alignment Film Side)——

As described above, in order to vertically align the liquid crystal compound having a polymerizable group, particularly, the disk-like liquid crystal compound having a polymerizable group, it is preferable to add an onium salt. The onium salt is localized within the interface of an alignment film and functions to increase the tilt angle of the liquid crystal molecule in the vicinity of the interface of the alignment film.

As the onium salt, a compound represented by General Formula (1) is preferable.

Z—(Y-L-)ₙCy⁺.X⁻ General Formula (1)

In the formula, Cy represents an onium group as a 5- or 6-membered ring. L, Y, Z, and X have the same definition as L²³, L²⁴, Y²², Y²³, Z²¹, and X respectively that are in General Formula (II) which will be described later, and a preferable range thereof is also the same. n represents an integer of equal to or greater than 2.

As the onium group (Cy) as a 5- or 6-membered ring, a pyrazolium ring, an imidazolium ring, a traizolium ring, a tetrazolium ring, a pyridinium ring, a pyrazinium ring, a pyrimidinium ring, and a triazinium ring are preferable, and an imidazolium ring and a pyridinium ring are particularly preferable.

It is preferable that the onium group (Cy) as a 5- or 6-membered ring has a group having affinity with the material of the alignment film. In a portion (unexposed portion) in which an acid generator is not decomposed, the onium salt compound exhibits high affinity with respect to the material of the alignment film and is localized within the interface of the alignment film. In contrast, in a portion (exposed portion) in which an acid generator is decomposed and generates an acidic compound, the affinity is reduced due to the ion exchange the anion of the onium salt undergoes, and hence the localization properties thereof within the interface of the alignment film deteriorates. Within the range of a temperature (at about a room temperature to 150° C.) actually used at the time of aligning the liquid crystals, hydrogen bonding can be established or disappear. Therefore, it is preferable to exploit the affinity by the hydrogen bonding, but the present invention is not limited to this example.

For example, in an aspect in which polyvinyl alcohol is used as the material of the alignment film, in order to form a hydrogen bond between the onium salt and a hydroxyl group of polyvinyl alcohol, it is preferable that the onium salt has a hydrogen bonding group. The theoretical interpretation of hydrogen bonding is reported in, for example, H. Uneyama and K. Morokuma, Journal of American Chemical Society, Vol. 99, pp. 1316-1332, 1977. Specific examples of the pattern of the hydrogen bonding include those described in J. N. Israelachvili, “Intermolecular Force and Surface Force”, translated by Tamotsu Kondo and Hiroyuki Oshima, McGraw-Hill Education, p. 98, FIG. 17, 1991. Specific examples of the hydrogen bonding include those described in G. R. Desiraju, Angewante Chemistry International Edition English, vol. 34, p. 2311, 1995.

In addition to the effect of the hydrophilicity of the onium group, by forming a hydrogen bond with polyvinyl alcohol, the onium group as a 5- or 6-membered ring having a hydrogen bonding group improves the surface localization properties within the interface of the alignment film and promotes the function of imparting orthogonal alignment properties with respect to the polyvinyl alcohol main chain. Examples of preferable hydrogen bonding groups include an amino group, a carbonamide group, a sulfonamide group, an acid amide group, a ureide group, a carbamoyl group, a carboxyl group, a sulfo group, and a nitrogen-containing heterocyclic group (for example, an imidazolyl group, a benzimidazolyl group, a pyrazolyl group, a pyridyl group, a 1,3,5-triazyl group, a pyrimidyl group, a pyridazyl group, a quinolyl group, a benzothiazolyl group, a succinimide group, a phthalimide group, a maleimide group, a uracil group, a thiouracil group, a barbituric acid group, a hydantoin group, a maleic acid hydrazide group, an isatin group, a uramil group, and the like). Among these hydrogen bonding groups, an amino group and a pyridyl group are more preferable.

For example, it is also preferable that the 5- or 6-membered onium ring contains an atom having a hydrogen bonding group just like a nitrogen atom of an imidazolium ring.

n is preferably an integer of 2 to 5, more preferably 3 or 4, and particularly preferably 3. A plurality of L's and Y's may be the same as or different from each other. In a case where n is equal to or greater than 3, the onium salt represented by General Formula (1) has three or more 5- or 6-membered rings. Accordingly, a strong intermolecular π-π interaction occurs between the onium salt and the disk-like liquid crystal compound. As a result, the vertical alignment of the disk-like liquid crystal compound can be realized, and particularly, on the polyvinyl alcohol alignment film, the orthogonal and vertical alignment with respect to the polyvinyl alcohol main chain can be realized.

The onium salt represented by General Formula (1) is particularly preferably a pyridinium compound represented by General Formula (2a) or an imidazolium compound represented by General Formula (2b).

The compounds represented by General Formulae (2a) and (2b) are added mainly for the purpose of controlling the alignment of the disk-like liquid crystal compound within the interface of the alignment film, and function to increase the tilt angle of the molecules of the disk-like liquid crystal compound in the vicinity of the interface of the alignment film.

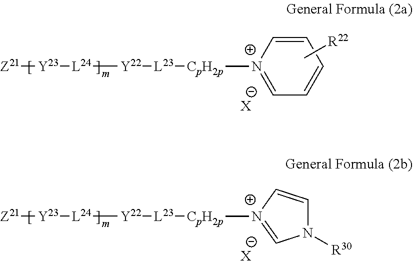

In the formulae, L²³ and L²⁴ each represent a divalent linking group.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—. AL is an alkylene group having 1 to 10 carbon atoms. L²³ is preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, more preferably a single bond or —O—, and most preferably —O—.

L²⁴ is preferably a single bond, —O—, —O—CO—, —CO—O—, —C≡C—, —CH═CH—, —CH═N—, —N═CH—, or —N═N—, and more preferably —O—CO— or —CO—O—. In a case where m is equal to or greater than 2, a plurality of L²⁴'s are even more preferably —O—CO— and —CO—O— that alternate with each other.

R²² is a hydrogen atom, an unsubstituted amino group, or a substituted amino group having 1 to 20 carbon atoms.

In a case where R²² is a dialkyl-substituted amino group, two alkyl groups may form a nitrogen-containing heterocyclic ring by being bonded to each other. The nitrogen-containing heterocyclic ring formed at this time is preferably a 5- or 6-membered ring. R²² is more preferably a hydrogen atom, an unsubstituted amino group, or a dialkyl-substituted amino group having 2 to 12 carbon atoms, and even more preferably a hydrogen atom, an unsubstituted amino group, or a dialkyl-substituted amino group having 2 to 8 carbon atoms. In a case where R²² is an unsubstituted amino group and a substituted amino group, it is preferable that the 4-position of a pyridinium ring is substituted.

X is an anion.

X is preferably a monovalent anion. Examples of the anion include a halide ion (a fluorine ion, a chlorine ion, a bromine ion, or an iodine ion) and a sulfonate ion (for example, a methanesulfonate ion, a p-toluenesulfonate ion, or a benzenesulfonate ion).

Y²² and Y²³ each represent a divalent linking group having a 5- or 6-membered ring as a partial structure.

The 5- or 6-membered ring may have a substituent. It is preferable that at least one of Y²² or Y²³ is a divalent linking group having a 5- or 6-membered ring, which has a substituent, as a partial structure. It is preferable that Y²² and Y²³ each independently represent a divalent linking group having a 6-membered ring, which may have a substituent, as a partial structure. The 6-membered ring includes an aliphatic ring, an aromatic ring (benzene ring), and a heterocyclic ring. Examples of the 6-membered aliphatic ring include a cyclohexane ring, a cyclohexene ring, and a cyclohexadiene ring. Examples of the 6-membered heterocyclic ring include a pyran ring, a dioxane ring, a dithian ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. Another 6-membered ring or 5-membered ring may be fused with the 6-membered ring.

Examples of the substituent include a halogen atom, a cyano group, an alkyl group having 1 to 12 carbon atoms, and an alkoxy group having 1 to 12 carbon atoms. The alkyl group and the alkoxy group may be substituted with an acyl group having 2 to 12 carbon atoms or an acyloxy group having 2 to 12 carbon atoms. As the substituent, an alkyl group having 1 to 12 carbon atoms (more preferably having 1 to 6 carbon atoms, and even more preferably having 1 to 3 carbon atoms) is preferable. The number of substituents may be equal to or greater than 2. For example, in a case where Y²² and Y²³ represent a phenylene group, the phenylene group may be substituted with one to four alkyl groups having 1 to 12 carbon atoms (more preferably having 1 to 6 carbon atoms, and even more preferably having 1 to 3 carbon atoms).

m is 1 or 2, and preferably 2. In a case where m is 2, a plurality of Y²³'S and L²⁴'s may be the same as or different from each other.

Z²¹ is a monovalent group selected from the group consisting of a halogen-substituted phenyl group, a nitro-substituted phenyl group, a cyano-substituted phenyl group, a phenyl group substituted with an alkyl group having 1 to 10 carbon atoms, a phenyl group substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyloxy group having 7 to 26 carbon atoms.

In a case where m is 2, Z²¹ is preferably a cyano group, an alkyl group having 1 to 10 carbon atoms, or an alkoxy group having 1 to 10 carbon atoms, and more preferably an alkoxy group having 4 to 10 carbon atoms.

In a case where m is 1, Z²¹ is preferably an alkyl group having 7 to 12 carbon atoms, an alkoxy group having 7 to 12 carbon atoms, an acyl-substituted alkyl group having 7 to 12 carbon atoms, an acyl-substituted alkoxy group having 7 to 12 carbon atoms, an acyloxy-substituted alkyl group having 7 to 12 carbon atoms, or an acyloxy-substituted alkoxy group having 7 to 12 carbon atoms.

An acyl group is represented by —CO—R, and an acyloxy group is represented by —O—CO—R. R is an aliphatic group (an alkyl group, a substituted alkyl group, an alkenyl group, a substituted alkenyl group, an alkynyl group, or a substituted alkynyl group) or an aromatic group (an aryl group or a substituted aryl group). R is preferably an aliphatic group, and more preferably an alkyl group or an alkenyl group.

p is an integer of 1 to 10, and is particularly preferably 1 or 2. CₚH₂ₚ represents a chain-like alkylene group which may have a branched structure. CₚH₂ₚ is preferably a linear alkylene group (—(CH₂)ₚ—).

In Formula (2b), R³⁰ is a hydrogen atom or an alkyl group having 1 to 12 carbon atoms (more preferably having 1 to 6 carbon atoms and even more preferably having 1 to 3 carbon atoms).

Among the compounds represented by Formula (2a) or (2b), compounds represented by Formula (2a′) or (2b′) are preferable.

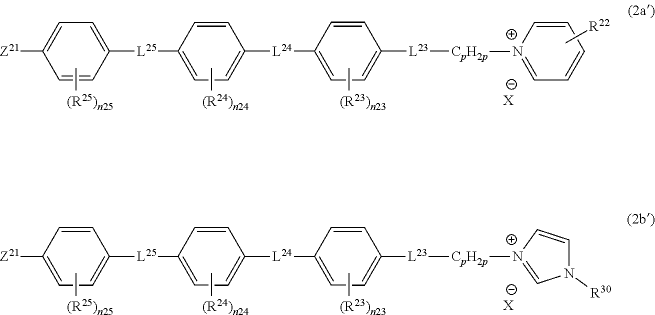

In Formulae (2a′) and (2b′), the same references as in Formula (2) have the same definition, and the preferable range thereof is also the same. L²⁵ has the same definition as L²⁴, and the preferable range thereof is also the same. L²⁴ and L²⁵ preferably represent —O—CO— or CO—O—. It is preferable that L²⁴ represents —O—CO—, and L²⁵ represents —CO—O—.

R²³, R²⁴, and R²⁵ each represent an alkyl group having 1 to 12 carbon atoms (more preferably having 1 to 6 carbon atoms, and even more preferably having 1 to 3 carbon atoms). n₂₃ represents 0 to 4, n₂₄ represents 1 to 4, and n₂₅ represents 0 to 4. It is preferable that n₂₃ and n₂₅ represent 0, and n₂₄ represents 1 to 4 (more preferably represents 1 to 3).

R³⁰ is preferably an alkyl group having 1 to 12 carbon atoms (more preferably having 1 to 6 carbon atoms, and even more preferably having 1 to 3 carbon atoms).

Specific examples of the compound represented by General Formula (1) include the compounds described in paragraphs <0058> to <0061> in the specification of JP2006-113500A.

Specific examples of the compound represented by General Formula (1) will be shown below. In the formulae, the anion (X⁻) is not shown.

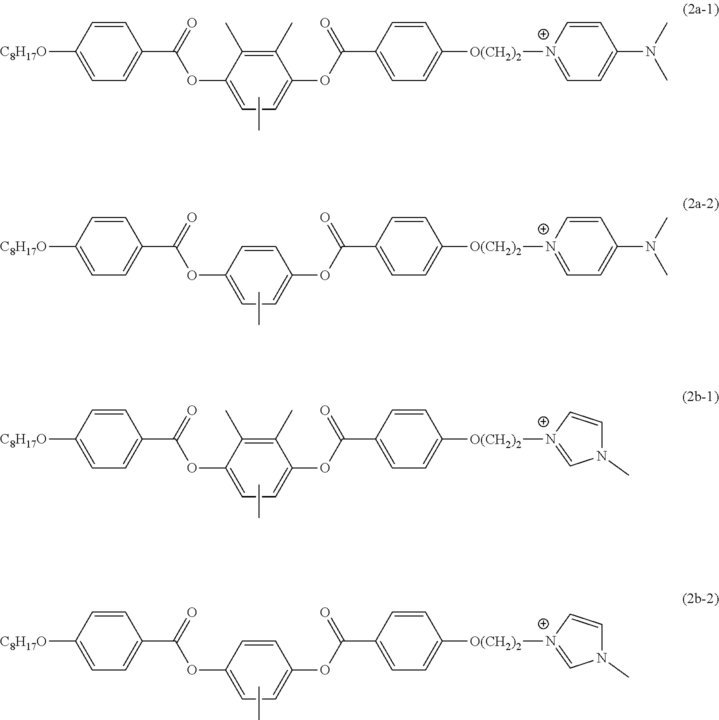

The compounds of Formula (2a) and (2b) can be manufactured by general methods. For example, a pyridinium derivative of Formula (2a) generally can be obtained by alkylating a pyridine ring (Menschutkin reaction).

The amount of the onium salt added does not exceed 5% by mass with respect to the liquid crystal compound, and is preferably about 0.1% to 2% by mass.

Because the pyridinium group or the imidazolium group is hydrophilic, the onium salts represented by General Formulae (2a) and (2b) are localized within the surface of the polyvinyl alcohol alignment film. Particularly, in a case where a pyridinium group is further substituted with an amino group which is a substituent of a hydrogen atom acceptor (in a case where R²² in General Formulae (2a) and (2a′) is an unsubstituted amino group or a substituted amino group having 1 to 20 carbon atoms), intermolecular hydrogen bonding occurs between the onium salts and polyvinyl alcohol, and hence the onium salts are localized within the surface of the alignment film at a higher density. Furthermore, due to the effect of the hydrogen bonding, the pyridinium derivative is aligned in a direction orthogonal to the main chain of polyvinyl alcohol, and accordingly, orthogonal alignment of the liquid crystals are promoted with respect to the rubbing direction. Because the pyridinium derivative has a plurality of aromatic rings in the molecule, strong intermolecular π-π interaction occurs between the pyridinium derivative and the liquid crystal, particularly, the disk-like liquid crystal compound described above, and as a result, the orthogonal alignment of the disk-like liquid crystal compound in the vicinity of the interface of the alignment film is induced. Particularly, in a case where a hydrophobic aromatic ring is linked to the hydrophilic pyridinium group as shown in General Formula (2a′), the effect of hydrophobicity brings about an effect of inducing vertical alignment.

In a case where the onium salts represented by General Formulae (2a) and (2b) are used in combination, anion exchange occurs between the onium salts and an acidic compound released from a photoacid generator due to photolysis, and the hydrogen bonding force and the hydrophilicity of the onium salts change. As a result, the localization properties of the onium salts within the interface of the alignment film deteriorate, and parallel alignment is promoted in which the liquid crystals are aligned in a state where the slow axis thereof is parallel to the rubbing direction. This is because due to the salt exchange, the onium salts are uniformly dispersed in the alignment film, the density of the onium salts within the surface of the alignment film is reduced, and the liquid crystals are aligned by the anchoring force of the rubbing alignment film.

Preferable examples of the onium salt compound (alignment control agent for the alignment film side) will be shown below, but the present invention is not limited thereto.

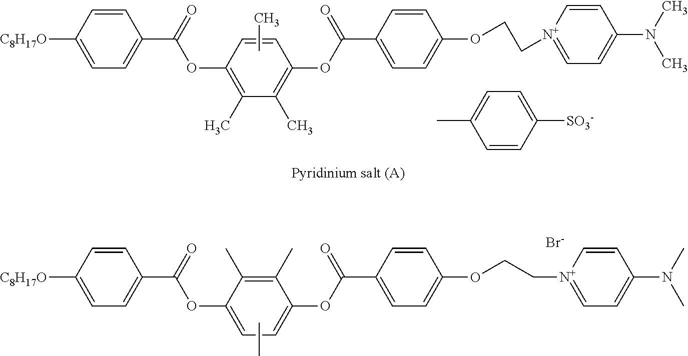

——Fluoroaliphatic Group-Containing Copolymer——

The fluoroaliphatic group-containing copolymer is added for the purpose of improving coating properties such as unevenness or cissing.

As the fluoroaliphatic group-containing copolymer usable in the present invention, it is possible to use those selected from the compounds described in JP2004-333852A, JP2004-333861A, JP2005-134884A, JP2005-179636A, and JP2005-181977A and the specifications thereof, and the like. Particularly, the polymers described JP2005-179636A and JP2005-181977A and the specifications thereof are preferable which contains, on a side chain, a fluoroaliphatic group and one or more kinds of hydrophilic groups selected from the group consisting of a carboxyl group (—COOH), a sulfo group (—SO₃H), phosphonooxy {—OP(═O)(OH)₂} and salts of these.

The amount of the fluoroaliphatic group-containing copolymer added does not exceed 2% by mass with respect to the liquid crystal compound, and is preferably about 0.1% to 1% by mass.

The fluoroaliphatic group-containing copolymer can improve the localization properties of the onium salt within the air interface by the hydrophobic effect of the fluoroaliphatic group, provide a field of low surface energy on the air interface side, and increase the tilt angle of the liquid crystal, particularly, the disk-like liquid crystal compound. Furthermore, in a case where the alignment control agent has a copolymer component containing, on a side chain, one or more kinds of hydrophilic groups selected from the group consisting of a carboxyl group (—COOH), a sulfo group (—SO₃H), phosphonooxy {—OP(═O)(OH)₂} and salts of these, due to the charge repulsion between these anions and π electrons of the liquid crystals, the vertical alignment of the liquid crystal compound can be realized.

Preferable examples of the fluoroaliphatic group-containing copolymer will be shown below, but the present invention is not limited thereto.

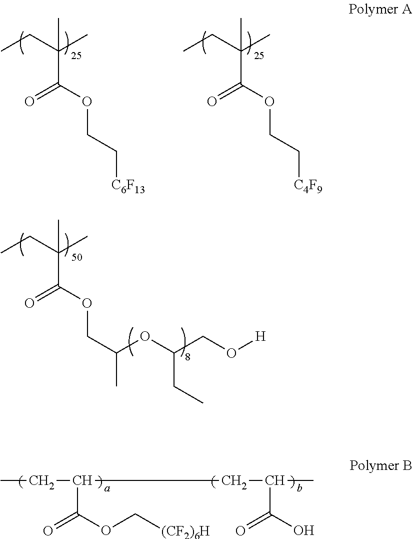

a is 90, and b is 10.

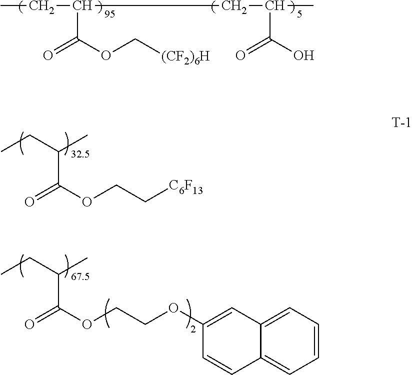

The amount of the fluoroaliphatic group-containing copolymer added to the liquid crystal composition with respect to the total mass of the liquid crystal compound is preferably 0.01% by mass to 10% by mass, more preferably 0.01% by mass to 5% by mass, and particularly preferably 0.02% by mass to 1% by mass.

—Polymerization Initiator—

Examples of the polymerization initiator include α-carbonyl compounds (described in the specifications of U.S. Pat. Nos. 2,367,661B and 2,367,670B), acyloin ethers (described in the specification of U.S. Pat. No. 2,448,828B), α-hydrocarbon-substituted aromatic acyloin compounds (described in the specification of U.S. Pat. No. 2,722,512B), polynuclear quinone compounds (described in the specifications of U.S. Pat. Nos. 3,046,127B and 2,951,758B), a combination of a triaryl imidazole dimer and p-aminophenylketone (described in the specification of U.S. Pat. No. 3,549,367B), acridine and phenazine compounds (described in the specifications of JP1985-105667A (JP-S60-105667A) and U.S. Pat. No. 4,239,850B), oxadiazole compounds (described in the specification of U.S. Pat. No. 4,212,970B), acylphosphine oxide compounds (described in the specifications of JP1988-40799B (JP-S63-40799B), JP1993-29234B (JP-H05-29234B), JP1998-95788A (JP-H10-95788A), JP1998-29997A (JP-H10-29997A)), and the like.

Examples of commercially available polymerization initiators include IRGACURE 907, IRGACURE 184, and IRGACURE OXE-01 (all manufactured by BASF SE) which are photopolymerization initiators, KAYACURE DETX (manufactured by Nippon Kayaku Co., Ltd.) which is a sensitizer, and the like.

In an aspect in which a polymerization reaction proceeds by ultraviolet irradiation, the polymerization initiator used is preferably a photopolymerization initiator which can initiate the polymerization reaction by ultraviolet irradiation.

The content of the photopolymerization initiator in the liquid crystal composition with respect to the content of the polymerizable liquid crystal compound is preferably 0.1% to 20% by mass, and more preferably 0.5% to 12% by mass.

—Solvent—

As the solvent of the liquid crystal composition, an organic solvent is preferably used. Examples of the organic solvent include an amide (for example, N,N-dimethylformamide), a sulfoxide (for example, dimethylsulfoxide), a heterocyclic compound (for example, pyridine), a hydrocarbon (for example, benzene or hexane), an alkyl halide (for example, chloroform or dichloromethane), an ester (for example, methyl acetate or butyl acetate), a ketone (for example, acetone, methyl ethyl ketone, cyclohexanone, or cyclopentanone), and an ether (for example, tetrahydrofuran or 1,2-dimethoxyethane). Among these, an alkyl halide and a ketone are preferable, and methyl ethyl ketone is more preferable. Two or more kinds of organic solvents may be used in combination.

(Method for Manufacturing Patterned Optical Anisotropic Layer)

Hereinafter, the method for manufacturing the patterned optical anisotropic layer (the first patterned optical anisotropic layer 13 and the second patterned optical anisotropic layer 14) usable in the present invention will be specifically described.

In the method for manufacturing the patterned optical anisotropic layer, the phase difference regions are preferably formed by using the liquid crystal composition, by using the same curable liquid crystal composition containing liquid crystals as a main component, or by pattern exposure.

As the method for forming the patterned optical anisotropic layer, for example, a method is preferable in which the liquid crystal compound is immobilized in the aligned state by using a liquid crystal composition containing a liquid crystal compound and the like. Examples of the method for immobilizing the liquid crystal compound used at this time suitably include a method of using a liquid crystal compound having a polymerizable group as a liquid crystal compound and polymerizing and immobilizing the liquid crystal compound, and the like. In the present invention, the patterned optical anisotropic layer can be formed on any support or polarizer and/or a polarizer, and the like. For forming the patterned optical anisotropic layer, a method of forming the patterned optical anisotropic layer on an alignment film which is formed in advance is also preferably used. The alignment film will be specifically described later.

More specifically, a first aspect for forming the patterned optical anisotropic layer is a method of exploiting a plurality of actions affecting the control of the liquid crystal alignment and then canceling one of the actions by using an external stimulus (a heat treatment or the like) such that a predetermined alignment control action becomes predominant.

For example, by using the alignment controllability by the alignment film and the alignment controllability of the alignment control agent added to the liquid crystal composition in combination, the liquid crystals are caused to be in a predetermined alignment state and immobilized such that one phase difference region is formed. Then, by using an external stimulus (a heat treatment or the like), one of the actions (for example, the action by the alignment control agent) is canceled such that the other alignment control action (the action based on the alignment film) becomes predominant. In this way, another alignment state is realized, and by immobilizing the alignment state, another phase difference region is formed. For example, because a pyridinium group or an imidazolium group is hydrophilic, a predetermined pyridinium compound or imidazolium compound is localized within the surface of the hydrophilic polyvinyl alcohol alignment film. Particularly, in a case where the pyridinium group is further substituted with an amino group which is a substituent of a hydrogen atom acceptor, intermolecular hydrogen bonding occurs between the pyridinium compound and polyvinyl alcohol. Accordingly, the pyridinium compound is localized on the surface of the alignment film at a higher density, and due to the effect of the hydrogen bonding, the pyridinium derivative is aligned in a direction orthogonal to the main chain of polyvinyl alcohol. As a result, the orthogonal alignment of the liquid crystals in the rubbing direction is promoted. Because the pyridinium derivative has a plurality of aromatic rings in the molecule, a strong intermolecular π-π interaction occurs between the pyridinium derivative and the liquid crystal, particularly, the disk-like liquid crystal compound described above, and consequently, the orthogonal alignment of the disk-like liquid crystal compound in the vicinity of the interface of the alignment film is induced. Particularly, in a case where a hydrophobic aromatic ring is linked to the hydrophilic pyridinium group, the effects of the hydrophobicity also brings about an effect of inducing vertical alignment. However, in a case where the compound is overheated to a certain temperature, the hydrogen bond is broken, the density of the pyridinium compound and the like within the surface of the alignment film is reduced, and hence the aforementioned effect disappears. As a result, the liquid crystals are aligned by the anchoring force of the rubbing alignment film and becomes a parallel alignment state. The aforementioned method is specifically described in paragraphs <0014> to <0132> in JP2012-8170A, the content of which is incorporated into the present specification by reference.

A second aspect for forming the patterned optical anisotropic layer is an aspect of using a patterned alignment film. In this aspect, patterned alignment films having different alignment controllabilities are formed, and the liquid crystal composition is disposed thereon, and the liquid crystals are aligned.

By the alignment controllabilities of the respective patterned alignment films, the alignment of the liquid crystals is controlled, and the liquid crystals achieve different alignment states respectively. By immobilizing the respective alignment states, patterns of the phase difference regions are formed according to the patterns of the alignment films. The patterned alignment films can be formed using a printing method, mask rubbing performed on a rubbing alignment film, mask exposure performed on a photoalignment film, or the like. Furthermore, it is possible to form the patterned alignment films by uniformly forming alignment films and printing additives (for example, the aforementioned onium salt and the like) affecting the alignment controllability on the alignment film according to predetermined patterns separately prepared. The printing method is specifically described in paragraphs <0013> to <0116> and <0166> to <0181> in JP2012-32661A, the content of which is incorporated into the present specification by reference. The mask exposure performed on the photoalignment film will be specifically described later in the section of the alignment film.

The first aspect and the second aspect may be used in combination. For example, a photoacid generator may be added to the alignment film. In this case, by adding the photoacid generator to the alignment film, two or more kinds of phase difference regions can be formed by setting the exposure amount (exposure intensity) to be a certain value or to be zero.

That is, by pattern exposure, a region in which the photoacid generator is decomposed, and thus an acidic compound is generated and a region in which the photoacid generator is not decomposed, and thus an acidic compound is not generated are formed. In the portion which is not irradiated with light, the photoacid generator substantially remains undecomposed. Therefore, the alignment state is controlled by the interaction among the material of the alignment film, the liquid crystals, and the alignment control agent which is added as desired, and the liquid crystals are aligned such that the slow axes thereof are orthogonal to the rubbing direction. In a case where the alignment film is irradiated with light, and thus an acidic compound is generated, the alignment state is controlled not by the aforementioned interaction but by the rubbing direction of the rubbing alignment film. Consequently, the liquid crystals are in parallel alignment in which the slow axes thereof are parallel to the rubbing direction. As the photoacid generator used in the alignment film, water-soluble compounds are preferably used. The aforementioned method is specifically described in paragraphs <0013> to <0175> in JP2012-150428A, the content of which is incorporated into the present specification by reference.

Preferable examples of the method used for forming the patterned optical anisotropic layer include a method using a patterned photoalignment film.

In the method for forming the patterned optical anisotropic layer, it is preferable to coat the surface of the patterned alignment film with one kind of composition which is prepared as a coating solution and contains liquid crystals having a polymerizable group as a main component. The coating with the liquid crystal composition can be performed by a method of spreading a material obtained by making the liquid crystal composition into a solution by using a solvent or a material obtained by making the liquid crystal composition into a liquid such as a molten liquid by means of heating, by an appropriate method such as a roll coating method, a gravure printing method, or a spin coating method. Furthermore, the coating with the liquid crystal composition can be performed by various methods such as a wire bar coating method, an extrusion coating method, a direct gravure coating method, a reverse gravure coating method, and a die coating method. In addition, a coating film can also be formed by jetting the liquid crystal composition from a nozzle by using an ink jet device.

After coating, it is preferable that the liquid crystal composition is dried or heated if necessary and then cured. It is preferable that the polymerizable liquid crystal compound in the liquid crystal composition is aligned by the step of drying or heating. In a case where heating is performed, the heating temperature is preferably equal to or lower than 200° C., and more preferably equal to or lower than 130° C.

It is preferable that the aligned liquid crystal compound is then subjected to polymerization. The polymerization may be any of the thermal polymerization and the photopolymerization by light irradiation, and among these, the photopolymerization is preferable. For the light irradiation, it is preferable to use ultraviolet. The irradiation energy is preferably 20 to 50 J/cm², and more preferably 100 to 1,500 mJ/cm². In order to accelerate the photopolymerization reaction, light irradiation may be performed under heating conditions or in a nitrogen atmosphere. The wavelength of the ultraviolet for irradiation is preferably 250 nm to 430 nm. From the viewpoint of the stability, it is preferable that the polymerization reaction rate is high, which is preferably equal to or higher than 70% and more preferably equal to or higher than 80%.

The polymerization reaction rate can be determined by measuring the proportion of the consumed polymerizable functional groups by using an IR absorption spectrum.

The optical properties of the liquid crystal composition based on the alignment of the liquid crystal compound molecules only need to be kept in the layer, and the liquid crystal composition of the patterned optical anisotropic layer obtained after curing does not need to exhibit the properties of liquid crystals. For example, the molecular weight of the liquid crystal composition may be increased by the curing reaction, and then the composition may lose the properties of liquid crystals.

In the formation of the patterned optical anisotropic layer, it is preferable that the alignment state of the patterned optical anisotropic layer is immobilized by the aforementioned curing. Herein, as the “immobilized” state of the liquid crystal phase, a state where the alignment of the liquid crystal compound is retained is a most typical and preferable aspect. However, the “immobilized” state of the liquid crystal phase is not limited thereto, and specifically means a state where the layer does not exhibit fluidity generally within a temperature range of 0° C. to 50° C. or within a temperature range of −30° C. to 70° C. under harsher conditions, and the immobilized alignment form can be stably maintained without changing the alignment form by an external field and/or an external force.

Examples of the method for manufacturing the patterned optical anisotropic layer used in an aspect of the laminate according to the embodiment of the present invention include a method of aligning the slow axes of the liquid crystals according to the alignment abilities of each of the regions of the patterned photoalignment film having different alignment abilities.

Furthermore, by the alignment state of the liquid crystals in these steps, the optical characteristics (Re and Rth) of the patterned optical anisotropic layer are determined.

The thickness of the patterned optical anisotropic layer formed as described above is not particularly limited, but is preferably 0.1 to 10 μm and more preferably 0.5 to 5 μm.

<Alignment Film>

The laminate according to the embodiment of the present invention may have an alignment film. For example, the laminate may have an alignment film adjacent to the patterned optical anisotropic layer. The alignment film has a function of controlling the alignment of liquid crystal molecules at the time of forming the patterned optical anisotropic layer (optically anisotropic layer).

The alignment film can be provided by means of a rubbing treatment of an organic compound (preferably a polymer), performing oblique vapor deposition of an inorganic compound such as SiO, forming a layer having microgrooves, and the like. In addition, alignment films (preferably photoalignment films) are also known which obtain the alignment function by being applied with an electric field or a magnetic field or being irradiated with light.

Depending on the material of the underlayer of the patterned optical anisotropic layer, even though the alignment film is not provided, it is possible to cause the underlayer to function as an alignment film by performing an alignment treatment (for example, a rubbing treatment) directly on the underlayer. Examples of supports that become such an underlayer include polyethylene terephthalate (PET).

In some cases, the underlayer functions as an alignment film on which a liquid crystal compound for preparing the patterned optical anisotropic layer or the optically anisotropic layer as an upper layer can be aligned. In these cases, even if an alignment film is not provided and a special alignment treatment (for example, a rubbing treatment) is not performed, the liquid crystal compound of the upper layer can be aligned.

Hereinafter, a photoalignment film as a preferable example will be described.

The materials of the photoalignment film used in a photoalignment film formed by light irradiation are described in a number of documents. Preferable examples of the materials include the azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, the aromatic ester compounds described in JP2002-229039A, the maleimide compounds having a photo-aligned unit and/or the alkenyl-substituted nadimide compounds described in JP2002-265541A and JP2002-317013A, the photo-crosslinking silane derivatives described in JP4205195B and JP4205198B, the photo-crosslinking polyimides, polyamides, or esters described in JP2003-520878A, JP2004-529220A, paragraphs <0024> to <0043> in WO2005/096041A, and JP4162850B, and the photodimerizable compounds, particularly, the cinnamate (cinnamic acid) compounds, the chalcone compounds, and the coumarin compounds described in JP1997-118717A (JP-H09-118717A), JP1998-506420A (JP-H10-506420A), JP2003-505561A, WO2010/150748A, paragraphs <0028> to <0176> in JP2012-155308A, JP2013-177561A, and JP2014-12823A. Among these, the azo compounds, the photo-crosslinking polyimides, polyamides, or esters, the cinnamate compounds, and the chalcone compounds are particularly preferable.

Specific examples of particularly preferable materials of the photoalignment film include the compound represented by General Formula (1) in JP2006-285197A and the liquid crystal alignment agents having a photo-aligned group described in paragraphs <0028> to <0176> in JP2012-155308A. As commercially available products of the photoalignment film, LPP-JP265CP (trade name) manufactured by Rolic Technologies Ltd and the like can be used.

By irradiating the film formed of the aforementioned materials with linearly polarized light or unpolarized light, the photoalignment film can be manufactured.

Furthermore, a patterned photoalignment film is preferably formed using mask exposure or the like for the photoalignment film at the time of irradiating the film with linearly polarized light or unpolarized light. For example, the patterned photoalignment film, which is for forming the patterned optical anisotropic layers used in the first aspect of the laminate of the present invention and have the first and second regions that exhibit alignment abilities in different directions in the plane thereof and alternate with each other, can be formed by irradiating a photoalignment film with linearly polarized light having a specific polarization direction and then irradiating the photoalignment film with linearly polarized light in a different polarization direction by using a photomask having a desired pattern shape (for example, glass to which aluminum foil is bonded may be used).

In addition, the patterned photoalignment film, which is for forming the patterned optical anisotropic layer of the laminate according to the embodiment of the present invention and has three or more regions which exhibit alignment abilities in different directions in the plane thereof and in which the directions of the alignment abilities continuously change, can be formed by repeating the following operation. In the operation, by an active energy ray irradiation device in which a polarizing plate and a light screen plate having a desired slit width are disposed, only a region corresponding to the slit width of the light screen plate is irradiated with linearly polarized light having a specific polarization direction, and thereafter, while the polarizing plate is being rotated by an arbitrary angle and the region corresponding to the slit width is being moved, the film is irradiated with linearly polarized light having a different polarization direction.

In the present specification, “irradiation with linearly polarized light” is an operation for causing a photoreaction in the material of a photoalignment film. The wavelength of the light used varies with the material of a photoalignment film used, and is not particularly limited as long as it is a wavelength necessary for the photoreaction. The peak wavelength of the light used for the light irradiation is preferably 200 nm to 700 nm. The light is more preferably ultraviolet rays having a peak wavelength of equal to or shorter than 400 nm.

Examples of light sources used for the light irradiation include generally used light sources such as lamps including a tungsten lamp, a halogen lamp, a xenon lamp, a xenon flash lamp, a mercury lamp, a mercury xenon lamp, and a carbon arc lamp, various lasers (for example, a semiconductor laser, a helium neon laser, an argon ion laser, a helium cadmium laser, and a YAG laser), a light emitting diode, a cathode ray tube, and the like.

As means for obtaining linearly polarized light, it is possible to adopt a method of using a polarizing plate (for example, an iodine polarizing plate, a dichroic colorant polarizing plate, or a wire-grid polarizing plate), a method of using a prism-based element (for example, a Glan-Thompson prism) or a reflective-type polarizer exploiting the Brewster's angle, a method of using light emitted from a laser light source exploiting polarization, and the like. Furthermore, by using a filter and/or a wavelength conversion element and the like, only the light having a necessary wavelength may be selectively radiated.

In a case where the radiated light is linearly polarized light, a method is adopted in which the alignment film is irradiated from the top side or the reverse side thereof with the light in a direction perpendicular or oblique to the surface of the alignment film. The incidence angle of the light varies with the material of the photoalignment film, but is 0° to 90° (vertical) and preferably 40° to 90° for example.

In a case where unpolarized light is used, the film is irradiated with the unpolarized light in an oblique direction. The incidence angle of the light is 10° to 80°, preferably 20° to 60°, and particularly preferably 30° to 50°.

The irradiation time is preferably 1 to 60 minutes, and more preferably 1 to 10 minutes.

Depending on the material of the alignment film selected, the alignment film can be peeled from a temporary support for forming the patterned optical anisotropic layer or the optically anisotropic layer, or only the patterned optical anisotropic layer can be peeled. By bonding the transferred patterned optical anisotropic layer which is in other words a peeled patterned optical anisotropic layer, a thin patterned optical anisotropic layer having a thickness of several micrometers can be provided. Furthermore, an aspect is also preferable in which a rubbing alignment film or a photoalignment film is directly laminated on the polarizer by coating, and an alignment function is imparted to the laminate by means of rubbing or a photoalignment treatment. That is, the laminate according to the embodiment of the present invention may be a laminate having a polarizer and a photoalignment film or a rubbing alignment film on the surface of the linear polarizer.

In the present invention, an aspect of using a photoalignment film as an alignment film is particularly preferable, because in this aspect, a pretilt angle of the polymerizable rod-like liquid crystal compound contained in the patterned optical anisotropic layer can be made 0°, and both the high contrast by which the light leakage in the front is reduced and the reduction in tint change in an oblique direction can be easily accomplished. It is preferable to impart the anchoring force to the photoalignment film used in the present invention by a step of irradiating the photoalignment film with polarized light in a vertical direction or an oblique direction or a step of irradiating the photoalignment film with unpolarized light in an oblique direction. The oblique direction adopted in a case where the photoalignment film is irradiated in an oblique direction is preferably a direction intersecting with the photoalignment film at an angle of 5° to 45°, and more preferably a direction intersecting with the photoalignment film at an angle of 10° to 30°. The photoalignment film may be irradiated with ultraviolet preferably at an irradiation intensity of 200 to 2,000 mJ/cm².

<Light-Transmitting Substrate>

The laminate of the present invention may include a light-transmitting substrate.

The light-transmitting substrate is a glass plate and a plastic substrate such as an acryl plate. For example, in a case where a polarizing plate is used, which is obtained by laminating two sheets of polarizers having absorption axes orthogonal to each other and exhibiting linear polarization ability, on the light-transmitting substrate, according to the incidence angle of light, the adjustment of the transmittance of transmitted light, that is, light control can be performed. Furthermore, even with the patterned optical anisotropic layer which will be described later, light control can be performed. The polarization ability mentioned herein refers to an ability to make linearly polarized light from unpolarized light and/or circularly polarized light or to convert linearly polarized light into circularly polarized light. The polarization ability can be changed by applying a phase difference.

As the light-transmitting substrate, it is possible to use glass plates used in general windows and plastic substrates such as an acryl plate, a polycarbonate plate, and a polystyrene plate.

The preferable range of a thickness of the light-transmitting substrate varies with the use. For building windows, the thickness of the light-transmitting substrate is generally 0.1 to 20 mm, and for windows for vehicles such as cars, the thickness of the light-transmitting substrate is generally 1 to 10 mm.

<Method for Manufacturing Laminate>

The method for manufacturing the laminate is not particularly limited.

The step of disposing the first patterned optical anisotropic layer and the second patterned optical anisotropic layer is not particularly limited. For example, by using a patterned optical anisotropic layer formed using the aforementioned method for manufacturing a patterned optical anisotropic layer, the first patterned optical anisotropic layer and the second patterned optical anisotropic layer can be disposed between the first polarizer and the second polarizer by a known method. At the time of preparing the laminate, for example, an adhesive and/or a pressure sensitive adhesive may be used, and each of the layers may be independently fixed by using a holding device such as a frame. Examples of the usable pressure sensitive adhesive include a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinyl pyrrolidone-based pressure sensitive adhesive, a polyacrylamide-based pressure sensitive adhesive, a cellulose-based pressure sensitive adhesive, and the like.

<Use>

The laminate according to the embodiment of the present invention can be used for a variety of uses that require light controllability or light blocking properties. Specifically, for example, the laminate can be suitably used in the field of video such as cameras, VTR, imaging lenses for projectors or the like, finders, filters, prisms, and a Fresnel lens, a field of lens such as pickup lenses for optical disks including CD players, DVD players, or MD players, a field of optical recording for optical disks such as CD players, DVD players, and MD players, a field of films for liquid crystal display such as light guide plates for liquid crystals, polarizing plate-protective films, or phase difference films, a field of information instrument such as surface protective films, a field of optical communication such as optical fibers, optical switches, and optical connectors, the field of vehicles such as car headlights, tail lamp lenses, inner lenses, instrument covers, and sunroofs, the field of medical instruments such as eyeglasses, contact lenses, lenses for endoscopes, and medical supplies that need to be sterilized, the field of construction.building materials such as light-transmitting plates for roads, lenses for double-glazed glass, lighting windows, carports, illumination lens, illumination covers, partitions of rooms, and siding boards for building materials, microwavable cooking containers (tableware), and the like. In addition, the laminate according to the embodiment of the present invention can be used for windows of various buildings such as buildings for residence including general houses and multiple dwelling houses and commercial buildings including office buildings. Furthermore, the laminate according to the embodiment of the present invention can be used not only for building windows but also for windows of vehicles such as cars. The laminate according to the embodiment of the present invention can also be used in the field of daily necessities such as picture frames and diary covers.

Among these, the laminate according to the embodiment of the present invention can be preferably used for the uses such as windows, partitions of rooms, picture frames, diary covers, and carports, and particularly preferably used for windows.

### EXAMPLES

Hereinafter, the present invention will be more specifically described based on examples and comparative examples. The materials, the amount and proportions of the materials used, the treatment content, the treatment procedure, and the like shown in the following examples can be appropriately modified within a range that does not depart from the gist of the present invention. Accordingly, the scope of the present invention is not limited to the specific examples described below.

### Example 1

<Preparation of Patterned Optical Anisotropic Layers PR1 and PR2>

(Formation of Patterned Photoalignment Film P1)

With reference to the method for preparing a liquid crystal aligning agent (S-3) of Example 3 described in JP2012-155308A, a coating solution for a photoalignment film 1 was prepared.

Then, a 10 cm×10 cm substrate prepared as a light-transmitting substrate was coated with the prepared coating solution for a photoalignment film 1 by a spin coating method, thereby forming a photoisomerization composition layer PA1.

Furthermore, by using a device, which was obtained by combining an ultraviolet irradiation device (EX250-W manufactured by HOYA-SCHOTT) with a polarizing plate and a light screen plate including a slit having a width of 2.78 mm, the obtained photoisomerization composition layer PA1 was irradiated with polarized ultraviolet at an irradiation amount of 500 mJ/cm².

At this time, whenever a single session of irradiation was finished, the glass substrate was moved by 2.78 mm, and whenever a single session of irradiation was finished, the polarizing plate was rotated by 5°. In this way, a patterned photoalignment film P1 having 36 regions was prepared in which the direction of the alignment ability varies among the respective regions.

(Preparation of Patterned Optical Anisotropic Layer PR1)

The patterned photoalignment film P1 was coated with a coating solution for an optically anisotropic layer 1 having the following composition by a spin coating method, heated for 30 seconds at 95° C., and irradiated with ultraviolet such that the alignment was immobilized, thereby forming a patterned optical anisotropic layer PR1.

Coating solution for optically anisotropic layer 1

| | | |
|---|---|---|
| Methyl ethyl ketone | 244.1 | parts by mass |
| Mixture of rod-like liquid crystal compounds shown below | 100.0 | parts by mass |
| IRGACURE 907 (manufactured by BASF SE) | 3.0 | parts by mass |
| KAYACURE DETX (manufactured by Nippon Kayaku Co., Ltd.) | 1.0 | part by mass |
| Fluoroaliphatic group-containing copolymer having structure shown | 0.6 | parts by mass |
| below (compound T-1 shown below) | | |

Rod-like liquid crystal compound

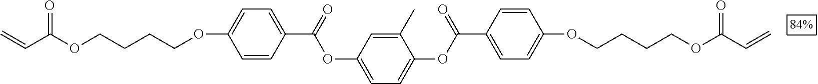 [SMILES: C=CC(=O)OCCCCOc1ccc(C(=O)Oc2ccc(OC(=O)c3ccc(OCCCCOC(=O)C=C)cc3)c(C)c2)cc1]

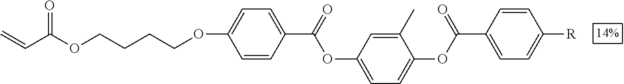

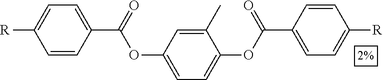

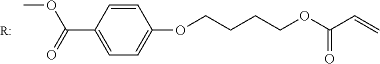

The unit of the numerical values is % by mass. The group represented by R is a partial structure shown on the lower right side, and is bonded to the compound through the side of an oxygen atom of this structure.

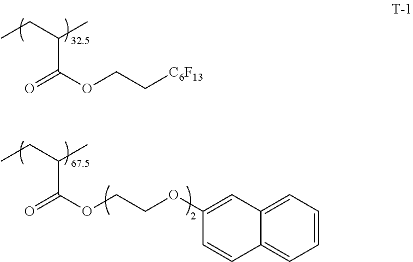

The patterned optical anisotropic layer PR1 had three or more rectangular phase difference regions which had different slow axis directions in the plane thereof and in which the slow axis directions continuously changed. More specifically, the patterned optical anisotropic layer PR1 had 36 phase difference regions in which a difference in angle between the slow axis directions of adjacent regions was 5° and the slow axis directions continuously changed up to about 180° from a phase difference region at one end of the optical anisotropic layer to a phase difference region at the other end of the optical anisotropic layer.

By using a device, which was obtained by combining an ultraviolet irradiation device (EX250-W manufactured by HOYA-SCHOTT) with a polarizing plate (without a light screen plate), the obtained photoisomerization composition layer PA1 was irradiated with polarized ultraviolet at an irradiation amount of 500 mJ/cm², thereby preparing a photoalignment film Al (without a pattern). By using the photoalignment film Al, a simulation sample for measuring optical characteristics was prepared according to the same procedure as in the patterned optical anisotropic layer PR1. By using the sample, Re(450), Re(550), Re(650), Rth(450), Rth(550), and Rth(650) of the patterned optical anisotropic layer PR1 were determined, and Re(450)/Re(550), Re(630)/Re(550), Rth(450)/Rth(550), and Rth(630)/Rth(550) were calculated. The patterned optical anisotropic layer PR1 was found to be a +A plate having normal wavelength dispersion. The optical characteristics of the patterned optical anisotropic layer PR1 are described in the tables shown below.

(Preparation of Patterned Optical Anisotropic Layer PR2)

The patterned photoalignment film P1 was coated with a coating solution for an optically anisotropic layer 2 having the following composition by a spin coating method, thereby forming a liquid crystal composition layer LC2.

The formed liquid crystal composition layer LC2 was heated for 60 seconds at 80° C. and irradiated with ultraviolet such that the alignment was immobilized, thereby forming a patterned optical anisotropic layer. In this way, a patterned optical anisotropic layer PR2 was prepared.

Coating solution for optically anisotropic layer 2

| | | |
|---|---|---|
| Discotic liquid crystal compound (A) shown below | 80 | parts by mass |
| Discotic liquid crystal compound (B) shown below | 20 | parts by mass |
| Ethylene oxide-modified trimethylolpropane triacrylate (V#360, | 5 | parts by mass |
| manufactured by OSAKA ORGANIC CHEMICAL INDUSTRY LTD) | | |
| Photopolymerization initiator (IRGACURE 907, manufactured by | 4 | parts by mass |
| BASF SE) | | |
| Onium salt compound (pyridinium salt (A) shown below) | 2 | parts by mass |
| Fluoroaliphatic group-containing copolymer (polymer A shown below) | 0.2 | parts by mass |
| Fluoroaliphatic group-containing copolymer (polymer B shown below) | 0.1 | parts by mass |
| Fluoroaliphatic group-containing copolymer (compound T-1 shown | 0.1 | parts by mass |
| below) | | |
| Methyl ethyl ketone | 211 | parts by mass |

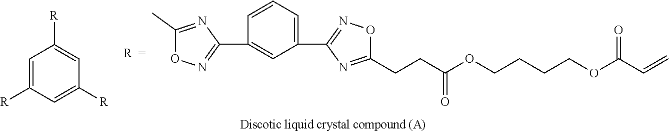

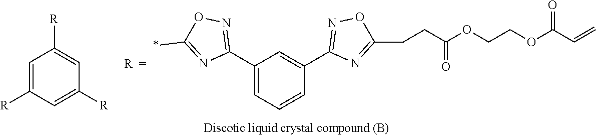

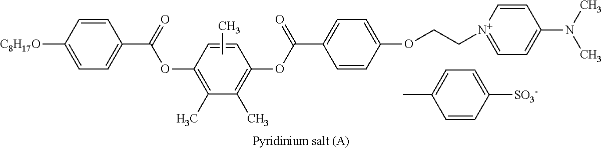

Polymer A

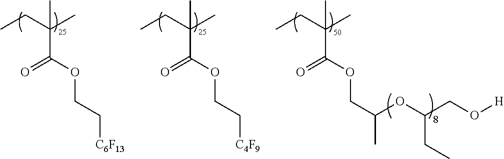

Polymer B

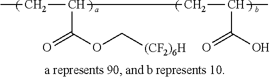

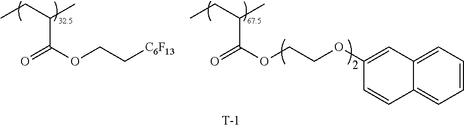

The patterned optical anisotropic layer PR2 had three or more rectangular phase difference regions which had different slow axis directions in the plane thereof and in which the slow axis directions continuously changed. More specifically, the patterned optical anisotropic layer PR2 had 36 phase difference regions in which a difference in angle between the slow axis directions of adjacent regions was 5° and the slow axis directions continuously changed up to about 180° from a phase difference region at one end of the optical anisotropic layer to a phase difference region at the other end of the optical anisotropic layer.

By using a device, which was obtained by combining an ultraviolet irradiation device (EX250-W manufactured by HOYA-SCHOTT) with a polarizing plate (without a light screen plate), the obtained photoisomerization composition layer PA1 was irradiated with polarized ultraviolet at an irradiation amount of 500 mJ/cm², thereby preparing a photoalignment film Al (without a pattern). By using the photoalignment film Al, a simulation sample for measuring optical characteristics was prepared according to the same procedure as in the patterned optical anisotropic layer PR2. By using the sample, Re(450), Re(550), Re(650), Rth(450), Rth(550), and Rth(650) of the patterned optical anisotropic layer PR2 were determined, and Re(450)/Re(550), Re(630)/Re(550), Rth(450)/Rth(550), and Rth(630)/Rth(550) were calculated. The patterned optical anisotropic layer PR2 was found to be a −A plate having normal wavelength dispersion. The optical characteristics of the patterned optical anisotropic layer PR2 are described in the following Table 1.

<Preparation of Laminate VF1 of Example 1>

(Preparation of Reflective-Type Linear Polarizer RPOL1)

A transparent polymer material 1 (polyethylene naphthalate) and a transparent polymer material 2 (polyethylene naphthalate) having different glass transition temperatures were supplied to a first extruder and a second extruder and heated such that the materials were melted. The materials were separately extruded as 51 layers from the first extruder and as 50 layers from the second extruder. Then, by using a multilayer feed block device alternately laminating the polymer materials 1 and 2, a laminated molten material constituted with 101 layers in total formed of the alternately laminated polymer materials 1 and 2 was obtained. In the laminated state, the molten material was uniaxially stretched at a temperature, which was in between the glass transition temperatures of the transparent polymer materials, until the reflectance with respect to polarized light in a direction orthogonal to the stretching direction was minimized, thereby preparing a reflective-type linear polarizer.

The reflection wavelength was controlled by adjusting the extrusion amount, and the polarizers having different reflection wavelength ranges were bonded and laminated after aligning the transmission axes for the polarized light, thereby preparing a reflective-type linear polarizer RPOL1 having a reflection wavelength range of 380 to 750 nm.

(Preparation of Optical Members OM1 and OM2)

The reflective-type linear polarizer RPOL1 was bonded to the glass side of the patterned optical anisotropic layer PR1 by using a commercially available pressure sensitive adhesive SK2057 (manufactured by Soken Chemical & Engineering Co., Ltd.), thereby preparing an optical member OM1. At this time, the positional relationship was set such that a long side of each of the phase difference regions of the patterned optical anisotropic layer PR1 became approximately parallel to the transmission axis of the reflective-type linear polarizer RPOL1.

Then, the reflective-type linear polarizer RPOL1 was bonded to the glass side of the patterned optical anisotropic layer PR2 by using a commercially available pressure sensitive adhesive SK2057 (manufactured by Soken Chemical & Engineering Co., Ltd.), thereby preparing an optical member OM2. At this time, the positional relationship was set such that an angle formed between a long side of each of the phase difference regions of the patterned optical anisotropic layer PR2 and the transmission axis of the reflective-type linear polarizer RPOL1 became about 90°.

(Preparation of Laminate VF1)

The optical member OM1 and the optical member OM2 were stacked such that the patterned optical anisotropic layer PR1 and the patterned optical anisotropic layer PR2 faced each other and had a positional relationship in which the patterned optical anisotropic layers can slide, thereby preparing a laminate VF1 of Example 1. At this time, the patterned optical anisotropic layer PR1 and the patterned optical anisotropic layer PR2 were positioned such that a long side of each of the phase difference regions of the patterned optical anisotropic layer PR1 became approximately parallel to a long side of each of the phase difference regions of the patterned optical anisotropic layer PR2, and the direction of a short side of each of the phase difference regions was adopted as a sliding direction. As a result, an angle formed between the transmission axis of the optical member OM1 and the transmission axis of the optical member OM2 became about 90°. Furthermore, by setting the sliding direction as described above, the way the phase difference regions of the patterned optical anisotropic layer PR1 and the phase difference regions of the patterned optical anisotropic layer PR2 are superposed can be arbitrarily changed by the sliding operation.

For the laminate VF1 prepared as above, a transmission display state, in which an angle formed between the slow axis direction of each of the phase difference regions of the first patterned optical anisotropic layer PR1 and the slow axis direction of each of the phase difference regions of the second patterned optical anisotropic layer PR2 that was superposed on each of the phase difference regions of the first patterned optical anisotropic layer PR1 was 45° and a transmittance obtained in a case where light incident on the first polarizer exited from the second polarizer was maximized, a light-blocking display state, in which an angle formed between the slow axis direction of each of the phase difference regions of the first patterned optical anisotropic layer PR1 and the slow axis direction of each of the phase difference regions of the second patterned optical anisotropic layer PR2 that was superposed on each of the phase difference regions of the first patterned optical anisotropic layer PR1 was 90° and a transmittance obtained in a case where the light incident on the first polarizer exited from the second polarizer was minimized, and a change between these states were observed from the optical member OM1 side.

VF1 displayed a transmission image and a reflection image superposed on each other in the transmission state and displayed only a reflection image in the light-blocking state. Between the transmission state and the light-blocking state, the transmittance smoothly changed over the entire laminate. Furthermore, even though the laminate was tilted in the light-blocking state, a transmission image was not observed (leakage of the transmitted light did not occur).

At the time of obliquely observing the laminate in the light-blocking state (oblique observation), the azimuthal angle of one end side of the phase difference regions of the first patterned optical anisotropic layer in the longitudinal direction was regarded as 0°, and the laminate was observed in a direction of a polar angle of 60° and an azimuthal angle of 0°. The longitudinal direction of the phase difference regions is in other words the longitudinal direction of the slit having a width of 2.78 mm used for forming the photoalignment film. The points described above are also applied to other examples.

### Example 2

<Preparation of Laminate VF2 of Example 2>

(Preparation of Absorptive-Type Linear Polarizer POLl)

The surface of supports, “TD80UL” and “Z-TAC” (all manufactured by FUJIFILM Corporation) as cellulose triacetate films, was subjected to an alkali saponification treatment. The films were immersed in a 1.5 N (1.5 mol/L) aqueous sodium hydroxide solution for 2 minutes at 55° C., washed with water in a rinsing bath at room temperature, and neutralized using 0.1 N (0.2 mol/L) sulfuric acid at 30° C. The films were then washed again with water in the rinsing bath at room temperature and dried with hot air with a temperature of 100° C.

Subsequently, a roll-like polyvinyl alcohol film having a thickness of 80 ptm was continuously stretched by 500% in an aqueous iodine solution and dried, thereby obtaining a film having a thickness of 20 ptm. By using an aqueous solution of a polyvinyl alcohol-based adhesive, TD80UL and Z-TAC were bonded to one surface and the other surface of the obtained film respectively, thereby obtaining an absorptive-type linear polarizer POLl.

An optical member OM3 was prepared in the same manner as in the optical member OM1, except that the absorptive-type linear polarizer POLl was used instead of the reflective-type linear polarizer RPOL1. At the time of preparing the optical member OM3, the absorptive-type linear polarizer POLl was bonded to the patterned optical anisotropic layer PR1 such that the “Z-TAC” side of POLl was positioned on the glass side of PR1. A laminate VF2 of Example 2 was prepared in the same manner as in the laminate VF1, except that the optical member OM3 was used instead of optical member OM1.

As a result of observing the prepared VF2 in the same manner as in VF1, VF2 was found to display only a transmission image in the transmission state and display only a reflection image in the light-blocking state. Between the transmission state and the light-blocking state, the transmittance smoothly changed over the entire laminate. Furthermore, even though the laminate was tilted in the light-blocking state, a transmission image was not observed.

### Comparative Example 1

The absorptive-type linear polarizer POLl was bonded to the glass side of the patterned optical anisotropic layer PR1 by using a commercially available pressure sensitive adhesive SK2057 (manufactured by Soken Chemical & Engineering Co., Ltd.), thereby preparing an optical member OM4. At this time, the positional relationship was set such that an angle formed between a long side of each of the phase difference regions of the patterned optical anisotropic layer PR1 and the transmission axis of the absorptive-type linear polarizer became about 90°.

A laminate VF3 of Comparative Example 1 was prepared in the same manner as in the laminate VF1, except that in the preparation of the laminate VF1, the optical member OM3 and the optical member OM4 were used instead of the optical member OM1 and the optical member OM2.

As a result of observing VF3 in the same manner as in VF1, VF3 was found to display only a transmission image in the transmission state and display black in the light-blocking state practically without displaying any image. Between the transmission state and the light-blocking state, the transmittance smoothly changed over the entire laminate. However, in a case where the laminate was tilted in the light-blocking state, a transmission image was observed (leakage of transmitted light occurred).

### Comparative Example 2

The reflective-type linear polarizer RPOL1 was bonded to the glass side of the patterned optical anisotropic layer PR1 by using a commercially available pressure sensitive adhesive SK2057 (manufactured by Soken Chemical & Engineering Co., Ltd.), thereby preparing an optical member OM5. At this time, the positional relationship was set such that an angle formed between a long side of each of the phase difference regions of the patterned optical anisotropic layer PR and the transmission axis of the reflective-type linear polarizer RPOL1 became about 90°.

A laminate VF4 of Comparative Example 2 was prepared in the same manner as in the laminate VF1, except that in the preparation of the laminate VF1, the optical member OM1 and the optical member OM5 were used instead of the optical member OM1 and the optical member OM2.

As a result of observing the prepared VF4 in the same manner as in VF1, VF4 was found to display a transmission image and a reflection image superposed on each other in the transmission state and display only a reflection image in the light-blocking state. Between the transmission state and the light-blocking state, the transmittance smoothly changed over the entire laminate. However, in a case where the laminate was tilted in the light-blocking state, a transmission image was observed.

### Comparative Example 3

<Preparation of Laminate VF5 Having Alternating Pattern>

A photoisomerization composition layer PA1 having a width of 10 cm was formed in the same manner as in Example 1.

Then, by using a device, which was obtained by combining an ultraviolet irradiation device (EX250-W manufactured by HOYA-SCHOTT) with a polarizing plate, the entire surface of the photoisomerization composition layer PA1 was irradiated with polarized ultraviolet at an irradiation amount of 500 mJ/cm². At this time, the polarization direction was set such that the light intersected with a side of the glass substrate at 45°.

Furthermore, glass to which aluminum foils were bonded at an interval of 1 cm was prepared, the glass was disposed between the polarized ultraviolet irradiation device and the photoisomerization composition layer PA1, and the photoisomerization composition layer PA1 was irradiated with the polarized ultraviolet at an irradiation amount of 500 mJ/cm² in the same manner as described above except that the polarization direction was rotated 90° from 45° such that the light intersected with the glass substrate at an angle of 135°.

In this way, a patterned photoalignment film P2 was prepared which had five regions that exhibited alignment abilities in directions intersecting with each other at an angle of 90°.

(Preparation of Patterned Optical Anisotropic Layer PR3)

The patterned photoalignment film P2 was coated with the coating solution for an optically anisotropic layer 1 by a spin coating method, heated for 30 seconds at 95° C. and irradiated with ultraviolet such that the alignment was immobilized, thereby forming a patterned optical anisotropic layer. In this way, a patterned optical anisotropic layer PR3 was prepared. At this time, in order that Re of the patterned optical anisotropic layer PR3 became the value in Table 1, the spin coating conditions were adjusted.

The patterned optical anisotropic layer PR3 had first phase difference regions and second phase difference regions which had different slow axis directions in the plane thereof and alternated with each other, and an angle formed between the slow axis direction of each of the first phase difference regions and the slow axis direction of each of the second phase difference regions was 90°.

The reflective-type linear polarizer RPOL1 was bonded to the glass side of the patterned optical anisotropic layer PR3 by using a commercially available pressure sensitive adhesive SK2057 (manufactured by Soken Chemical & Engineering Co., Ltd.), thereby preparing an optical member OM6. At this time, the positional relationship was set such that a long side of each of the phase difference regions of the patterned optical anisotropic layer PR3 became approximately parallel to the transmission axis of the reflective-type linear polarizer RPOL1.

Then, the reflective-type linear polarizer RPOL1 was bonded to the glass side of the patterned optical anisotropic layer PR3 by using a commercially available pressure sensitive adhesive SK2057 (manufactured by Soken Chemical & Engineering Co., Ltd.), thereby preparing an optical member OM7, in a positional relationship in which an angle formed between a long side of each of the phase difference regions of the patterned optical anisotropic layer PR3 and the transmission axis of the reflective-type linear polarizer RPOL1 became about 90°.

A laminate VF5 of Comparative Example 3 was prepared in the same manner as in the laminate VF1, except that in the preparation of the laminate VF1, the optical member OM6 and the optical member OM7 were used instead of the optical member OM1 and the optical member OM2.

As a result of observing the prepared VF5 in the same manner as in VF1, VF5 was found to display a transmission image and a reflection image superposed on each other in the transmission state and display only a reflection image in the light-blocking state. Between the transmission state and the light-blocking state, regions of a high transmittance and regions of a low transmittance were mixed together in the form of streaks. Furthermore, in a case where the laminate was tilted in the light-blocking state, a transmission image was observed.

[Evaluation]

The laminates VF1 to VF5 of examples and comparative examples were observed in the transmission display state (evaluation by front observation), the light-blocking display state (evaluation by front observation and evaluation by oblique observation), and the intermediate display state (change between the transmission display and light-blocking display). The observation results are summarized in the following Table 1. As described above, the oblique direction mentioned herein is a direction of an azimuthal angle of 0° and a polar angle of 60°.

In the transmission display state, in a case where only a transmission image was observed, the laminate was evaluated as A, and in a case where a transmission image and a reflection image were observed, the laminate was evaluated as B.

In the intermediate display state, in a case where the whole laminate smoothly changed when the first patterned anisotropic layer was moved in the sliding direction from the transmission display to the light-blocking display, the laminate was evaluated as A, and in a case where the laminate changed mottled and shows streaks, the laminate was evaluated as B.

Furthermore, in the light-blocking display state, in a case where a reflection image could be observed when the laminate was observed from the front, the laminate was evaluated as A, and in a case where the laminate displayed black, the laminate was evaluated as B. In a case where a transmission image was not observed when the laminate was observed in an oblique direction (in a case where the leakage of transmitted light did not occur), the laminate was evaluated as A, and in a case where a transmission image was observed (in a case where the leakage of transmitted light occurred), the laminate was evaluated as B. For any of the items, it is more preferable that the laminate is evaluated as A.

TABLE 1

| | | | | | Comparative | Comparative | Comparative |
|---|---|---|---|---|---|---|---|
| | | | Example 1 | Example 2 | Example 1 | Example 2 | Example 3 |
| Name of laminate | | | VF1 | VF2 | VF3 | VF4 | VF5 |
| First polarizer | | | Reflective-type | Absorptive-type | Absorptive-type | Reflective-type | Reflective-type |
| | | | polarizer | polarizer | polarizer | polarizer | polarizer |
| First | Type | | Phase difference | Phase difference | Phase difference | Phase difference | Phase difference |
| patterned | | | of continuous | of continuous | of continuous | of continuous | of alternating |
| optical | | | pattern (+A, | pattern (+A, | pattern (+A, | pattern (+A, | pattern (+A, |
| anisotropic | | | using rod-like | using rod-like | using rod-like | using rod-like | using rod-like |
| layer | | | liquid crystal) | liquid crystal) | liquid crystal) | liquid crystal) | liquid crystal) |
| | Optical | Rel(550) | 240 | 240 | 240 | 240 | 240 |
| | characteristics | Rthl(550) | 120 | 120 | 120 | 120 | 120 |
| | Wavelength | Rel(450)/Rel(550) | 1.1 | 1.1 | 1.1 | 1.1 | 1.1 |
| | dispersion | Rel(630)/Rel(550) | 0.97 | 0.97 | 0.97 | 0.97 | 0.97 |
| | | Rthl(450)/Rthl(550) | 1.1 | 1.1 | 1.1 | 1.1 | 1.1 |
| | | Rthl(630)/Rthl(550) | 0.97 | 0.97 | 0.97 | 0.97 | 0.97 |
| First | Type | | Phase difference | Phase difference | Phase difference | Phase difference | Phase difference |
| patterned | | | of continuous | of continuous | of continuous | of continuous | of alternating |
| optical | | | pattern (−A, | pattern (−A, | pattern (+A, | pattern (+A, | pattern (+A, |
| anisotropic | | | using disk-like | using disk-like | using rod-like | using rod-like | using disk-like |
| layer | | | liquid crystal) | liquid crystal) | liquid crystal) | liquid crystal) | liquid crystal) |
| | Optical | Rel(550) | 240 | 240 | 240 | 240 | 240 |
| | characteristics | Rthl(550) | −120 | −120 | 120 | 120 | 120 |
| | Wavelength | Rel(450)/Rel(550) | 1.1 | 1.1 | 1.1 | 1.1 | 1.1 |
| | dispersion | Rel(630)/Rel(550) | 0.97 | 0.97 | 0.97 | 0.97 | 0.97 |
| | | Rthl(450)/Rthl(550) | 1.1 | 1.1 | 1.1 | 1.1 | 1.1 |
| | | Rthl(630)/Rthl(550) | 0.97 | 0.97 | 0.97 | 0.97 | 0.97 |
| Second polarizer | | | Reflective-type | Reflective-type | Absorptive-type | Reflective-type | Reflective-type |
| | | | polarizer | polarizer | polarizer | polarizer | polarizer |
| Evaluation | Transmission | Evaluation by front | B (transmission | A (transmission | A (transmission | B (transmission | B (transmission |
| | display state | observation | image + | image only, | image only, | image + | image + |
| | | | reflection image) | easy to see) | easy to see) | reflection image) | reflection image) |
| | Intermediate | Change between | A (entire | A (entire | A (entire | A (entire | B (streak-like |
| | display state | transmission display | laminate | laminate | laminate | laminate | mottle) |
| | | and light-blocking | smoothly | smoothly | smoothly | smoothly | |
| | | display | changed) | changed) | changed) | changed) | |
| | Light-blocking | Evaluation by front | A (reflection | A (reflection | B (black | A (reflection | A (reflection |
| | display state | observation | image) | image) | display) | image) | image) |
| | | Evaluation by | A (no | A (no | B (visible | B (visible | B (visible |
| | | oblique* | transmission | transmission | transmission | transmission | transmission |
| | | observation | image) | image) | image) | image) | image) |

*polar angle: 60°, azimuthal angle: 0°

As is evident from Table 1, Comparative Examples 1 to 3 have problems such as incapable of displaying a reflection image during the light-blocking state, displaying a transmission image in a case where the laminate is tilted during the light-blocking state (occurrence of leakage of the transmitted light), and incapable of performing display in between the transmission state and the light-blocking state.

In contrast, it has been revealed that the laminate according to the embodiment of the present invention can adjust the transmittance between the transmission display state and the light-blocking display state, can display a reflection image without displaying black in the light-blocking display state, and causes less leakage of transmitted light in a case where the laminate is observed from the front and in an oblique direction in the light-blocking display state. Furthermore, it has been revealed that in a case where the laminate according to the embodiment of the present invention has a constitution in which an absorptive-type polarizer is used as a polarizer on the viewing side, the visibility in the transmission display state can be further improved.

### EXPLANATION OF REFERENCES

11: first polarizer
11A: transmission axis of first polarizer
12: second polarizer
12A: transmission axis of second polarizer
13: first patterned optical anisotropic layer
14: second patterned optical anisotropic layer

1. A laminate comprising:
a first polarizer;
a first patterned optical anisotropic layer;
a second patterned optical anisotropic layer; and
a second polarizer in this order,
wherein an angle formed between a transmission axis of the first polarizer and a transmission axis of the second polarizer is 90°±5°,
each of the first patterned optical anisotropic layer and the second patterned optical anisotropic layer has three or more phase difference regions, which have different slow axis directions and in which the slow axis directions continuously change, in a plane of each of the first patterned optical anisotropic layer and the second patterned optical anisotropic layer,
a transmission display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 45°±5° and a transmittance obtained in a case where light incident on the first polarizer exits from the second polarizer is maximized, and a light-blocking display state, in which an angle formed between the slow axis direction of each of the phase difference regions of the first patterned optical anisotropic layer and the slow axis direction of each of the phase difference regions of the second patterned optical anisotropic layer that is superposed on each of the phase difference regions of the first patterned optical anisotropic layer is 90°±5° and the transmittance obtained in a case where the light incident on the first polarizer exits from the second polarizer is minimized, are switched with each other,
a combination of the first patterned optical anisotropic layer and the second patterned optical anisotropic layer is a combination of a +A plate and a −A plate, and
at least one of the first polarizer or the second polarizer is a reflective-type polarizer.

2. The laminate according to claim 1,
wherein one of the first polarizer and the second polarizer is a reflective-type polarizer and the other is an absorptive-type polarizer.

3. The laminate according to claim 1,
wherein a retardation Re1(550) of the first patterned optical anisotropic layer at a wavelength of 550 nm in an in-plane direction of the first patterned optical anisotropic layer, a retardation Rth1(550) of the first patterned optical anisotropic layer at a wavelength of 550 nm in a film thickness direction of the first patterned optical anisotropic layer, a retardation Re2(550) of the second patterned optical anisotropic layer at a wavelength of 550 nm in an in-plane direction of the second patterned optical anisotropic layer, and a retardation Rth2(550) of the second patterned optical anisotropic layer at a wavelength of 550 nm in a film thickness direction of the second patterned optical anisotropic layer satisfy Formula (1) and Formula (2)
Re2(550)=Re1(550)±25 nm (1)
Rth2(550)=−Rth1(550)±25 nm (2)

4. The laminate according to claim 1,
wherein the retardation Re1(550) of the first patterned optical anisotropic layer at a wavelength of 550 nm in the in-plane direction of the first patterned optical anisotropic layer and the retardation Re2(550) of the second patterned optical anisotropic layer at a wavelength of 550 nm in the in-plane direction of the second patterned optical anisotropic layer are each independently 230 to 270 nm and satisfy Formula (1)
Re2(550)=Re1(550)±25 nm (1)

5. The laminate according to claim 2,
wherein the retardation Re1(550) of the first patterned optical anisotropic layer at a wavelength of 550 nm in the in-plane direction of the first patterned optical anisotropic layer and the retardation Re2(550) of the second patterned optical anisotropic layer at a wavelength of 550 nm in the in-plane direction of the second patterned optical anisotropic layer are each independently 230 to 270 nm and satisfy Formula (1)
Re2(550)=Re1(550)±25 nm (1).

6. The laminate according to claim 3,
wherein the retardation Re1(550) of the first patterned optical anisotropic layer at a wavelength of 550 nm in the in-plane direction of the first patterned optical anisotropic layer and the retardation Re2(550) of the second patterned optical anisotropic layer at a wavelength of 550 nm in the in-plane direction of the second patterned optical anisotropic layer are each independently 230 to 270 nm and satisfy Formula (1)
Re2(550)=Re1(550)±25 nm (1).

7. The laminate according to claim 1,
wherein both the first patterned optical anisotropic layer and the second patterned optical anisotropic layer have normal wavelength dispersion as wavelength dispersion of the retardation Re in the in-plane direction of the first patterned optical anisotropic layer and the second patterned optical anisotropic layer, and
both the first patterned optical anisotropic layer and the second patterned optical anisotropic layer have normal wavelength dispersion as wavelength dispersion of the retardation Rth in the film thickness direction of the first patterned optical anisotropic layer and the second patterned optical anisotropic layer.

8. The laminate according to claim 4,
wherein both the first patterned optical anisotropic layer and the second patterned optical anisotropic layer have normal wavelength dispersion as wavelength dispersion of the retardation Re in the in-plane direction of the first patterned optical anisotropic layer and the second patterned optical anisotropic layer, and
both the first patterned optical anisotropic layer and the second patterned optical anisotropic layer have normal wavelength dispersion as wavelength dispersion of the retardation Rth in the film thickness direction of the first patterned optical anisotropic layer and the second patterned optical anisotropic layer.

9. The laminate according to claim 1,
wherein the first patterned optical anisotropic layer and the second patterned optical anisotropic layer contain a liquid crystal compound.

10. The laminate according to claim 4,
wherein the first patterned optical anisotropic layer and the second patterned optical anisotropic layer contain a liquid crystal compound.

11. The laminate according to claim 1,
wherein at least one of the first patterned optical anisotropic layer or the second patterned optical anisotropic layer contains a disk-like liquid crystal compound.

12. The laminate according to claim 4,
wherein at least one of the first patterned optical anisotropic layer or the second patterned optical anisotropic layer contains a disk-like liquid crystal compound.

13. The laminate according to claim 11,
wherein one of the first patterned optical anisotropic layer and the second patterned optical anisotropic layer contains a disk-like liquid crystal compound and the other contains a rod-like liquid crystal compound.

14. The laminate according to claim 12,
wherein one of the first patterned optical anisotropic layer and the second patterned optical anisotropic layer contains a disk-like liquid crystal compound and the other contains a rod-like liquid crystal compound.

15. A window comprising the laminate according to claim 1.

16. A window comprising the laminate according to claim 4.
